(19) United States
(12) Patent Application Publication
(10) Pub. No.: US 2013/0339271 A1
(43) Pub. Date: Dec. 19, 2013

(54) EVALUATION SYSTEM, EVALUATION METHOD, AND STORAGE MEDIUM

(71) Applicants: Yuuji KASUYA, Kanagawa (JP); Taro Okuyama, Tokyo (JP); Kiwamu Watanabe, Kanagawa (JP); Zhi Min, Saitama (JP); Taiji Shudoh, Kanagawa (JP)

(72) Inventors: Yuuji KASUYA, Kanagawa (JP); Taro Okuyama, Tokyo (JP); Kiwamu Watanabe, Kanagawa (JP); Zhi Min, Saitama (JP); Taiji Shudoh, Kanagawa (JP)

(73) Assignee: RICOH COMPANY, LTD., Tokyo (JP)

(21) Appl. No.: 13/918,050

(22) Filed: Jun. 14, 2013

(30) Foreign Application Priority Data
Jun. 19, 2012 (JP) 2012-138167

(51) Int. Cl. G06Q 30/02

(52) U.S. Cl. CPC G06Q 30/0282
USPC 705/347

(57) ABSTRACT

An evaluation system includes a device including a processor and a memory storing a program and a first external apparatus. The program is configured to cause the processor to function as an action detecting unit that detects a predefined action, an identification information obtaining unit that obtains identification information of an evaluation target when the predefined action is detected by the action detecting unit, an identification information storing unit that stores the obtained identification information in a storage, and a transmitting unit that transmits the identification information stored in the storage to the first external apparatus. The first external apparatus includes an evaluation information calculating unit that calculates and updates evaluation information of the evaluation target associated with the identification information received from the device.

### CROSS-REFERENCE TO RELATED APPLICATION

The present application is based upon and claims the benefit of priority of Japanese Patent Application No. 2012-138167, filed on Jun. 19, 2012, the entire contents of which are incorporated herein by reference.

### BACKGROUND OF THE INVENTION

1. Field of the Invention

An aspect of this disclosure relates to an evaluation system.

2. Description of the Related Art

Product and service providers conduct various sales promotional activities to promote the sales of their products and services. Meanwhile, the advancement of communication technologies has made it possible for a customer (which may be hereafter referred to as an “evaluator”) to evaluate products and services and share the evaluation results with other evaluators via, for example, the Web. For example, there exists a Web site that allows an evaluator to submit a review of a product. Potential buyers (or customers) of products and services tend to take into account such evaluation results provided by evaluators in addition to information provided by product and service providers.

Japanese Laid-Open Patent Publication No. 2011-96259, for example, discloses a technology for publishing the results of evaluation of various types of information conducted by evaluators on the Internet. Japanese Laid-Open Patent Publication No. 2011-96259 also discloses a technology to evaluate a message by pressing a corresponding button, and to report the evaluation result to the sender of the message or display the evaluation result in a list.

Meanwhile, Japanese Patent No. 4753616, for example, discloses a technology for collecting the results of evaluation of “real-world” objects instead of information on the Web. More specifically, Japanese Patent No. 4753616 discloses a product information analysis and retrieval system that analyzes types of customer activities such as “picking up a product”, “putting the product back on the shelf”, “bringing the product into a fitting room”, “purchasing the product”, and “not purchasing the product” via an IC tag attached to the product and antennas for identifying the IC tag; stores information on those customer activities as purchasing behavior information in association with customers and time; obtains statistics of the purchasing behavior information weighted by coefficients that are preset for the respective activity types via an input/output unit; and sends the statistics and the purchasing behavior information, based on which the statistics are obtained, in response to a request from the input/output unit.

### SUMMARY OF THE INVENTION

In an aspect of this disclosure, there is provided an evaluation system that includes a device including a processor and a memory storing a program and a first external apparatus. The program is configured to cause the processor to function as an action detecting unit that detects a predefined action, an identification information obtaining unit that obtains identification information of an evaluation target when the predefined action is detected by the action detecting unit, an identification information storing unit that stores the obtained identification information in a storage, and a transmitting unit that transmits the identification information stored in the storage to the first external apparatus. The first external apparatus includes an evaluation information calculating unit that calculates and updates evaluation information of the evaluation target associated with the identification information received from the device.

### BRIEF DESCRIPTION OF THE DRAWINGS

FIGS. 1A through 2B are drawings used to describe an exemplary schematic process performed in an evaluation system according to a first embodiment;

FIG. 3 is a schematic diagram illustrating an exemplary configuration of an evaluation system of the first embodiment;

FIG. 4 is a block diagram illustrating an exemplary hardware configuration of an evaluation device;

FIG. 5 is a block diagram illustrating an exemplary hardware configuration of a server;

FIGS. 6A and 6B are block diagrams illustrating an exemplary functional configuration of an evaluation system of the second embodiment;

FIGS. 7A and 7B are drawings illustrating exemplary IDs displayed on a display unit;

FIG. 8A is an example of an evaluation result table;

FIG. 8B is an example of a target identification table;

FIGS. 9A and 9B are drawings illustrating an exemplary top page displayed on a browsing client;

FIGS. 10A through 100 are flowcharts illustrating exemplary processes performed by an evaluation device to evaluate a target;

FIG. 11 is a flowchart illustrating an exemplary process performed by an action detecting unit to detect a gesture;

FIG. 12 is a flowchart illustrating an exemplary process performed by a server to receive an ID;

FIG. 13 is a flowchart illustrating an exemplary process where a browsing client requests evaluation data from a server;

FIGS. 14A through 15C are drawings used to describe an exemplary schematic process performed in an evaluation system according to a second embodiment;

FIG. 16 is a schematic diagram illustrating an exemplary configuration of an evaluation system of the second embodiment;

FIGS. 17A and 17B are block diagrams illustrating an exemplary functional configuration of an evaluation system of the second embodiment;

FIG. 18 is a drawing illustrating an exemplary image database;

FIG. 19 is a drawing used to describe an exemplary visual search process;

FIG. 20 is a drawing used to describe an exemplary word boundary box determination algorithm;

FIG. 21 is a drawing illustrating grouping of words based on word boundaries;

FIG. 22 is a drawing used to describe a feature quantity represented by 0 and 1;

FIG. 23 is a drawing used to describe an exemplary method of calculating angles formed by word boundaries;

FIG. 24 is a drawing used to describe a feature quantity based on a word length;

FIG. 25 is a drawing used to describe an exemplary method of combining a vertical layout and a horizontal layout;

FIG. 26 is a drawing used to describe an exemplary method of combining horizontal trigram information and vertical trigram information obtained in FIG. 25; and

FIG. 27 is a flowchart illustrating an exemplary process where an evaluation device transmits image data to a search server.

### DESCRIPTION OF THE PREFERRED EMBODIMENTS

The related-art technology described in Japanese Laid-Open Patent Publication No. 2011-96259 merely allows an evaluator to evaluate products and services whose information is provided on the Web site. For example, according to the related-art technology, a Web site dedicated for a product needs to be prepared beforehand to allow an evaluator to submit a review of the product.

Also, with the product information analysis and retrieval system described in Japanese Patent No. 4753616, a customer cannot actively evaluate a product. In other words, with the related-art product information analysis and retrieval system, customer activities are automatically analyzed and the customer cannot intentionally evaluate a product.

Thus, the related-art technologies do not provide a mechanism that allows evaluators to actively or intentionally evaluate real-world products and services and share the evaluation results. An aspect of this disclosure makes it possible to solve or reduce one or more problems of the related art.

Preferred embodiments of the present invention are described below with reference to the accompanying drawings.

### First Embodiment

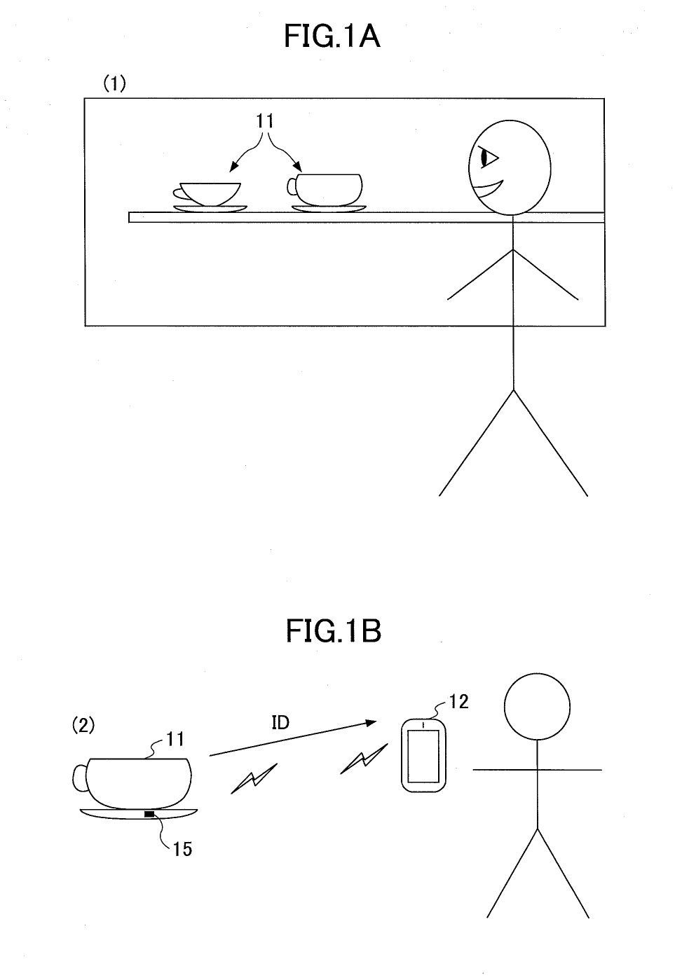

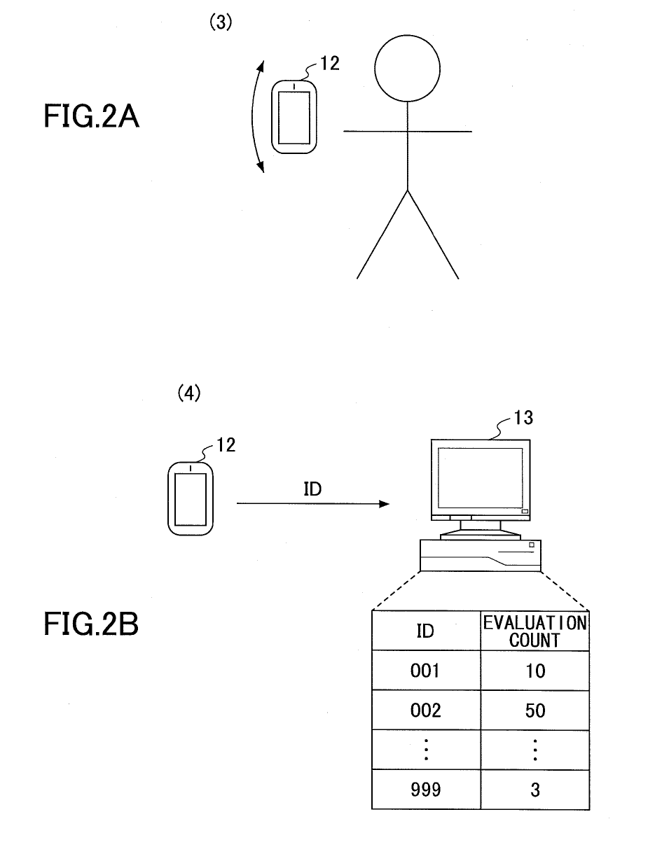

FIGS. 1A through 2B are drawings used to describe an exemplary schematic process performed in an evaluation system according to a first embodiment. In the descriptions below, numbers in parentheses correspond to those in FIGS. 1A through 2B.

(1) An evaluator carries an evaluation device 12. The evaluation device 12 is, for example, a portable communication terminal. When the evaluator comes across an interesting evaluation target 11 while moving in the real world, the evaluator may generally reduce walking speed or stop walking to look at the evaluation target 11.

(2) The evaluation device 12 is continuously operating to detect evaluation targets 11 that can communicate wirelessly. When such an evaluation target 11 is detected, the evaluation device 12 communicates with the evaluation target 11 and receives an ID (identification information) for identifying the evaluation target 11.

(3) When the evaluator wants to evaluate the evaluation target 11, the evaluator performs a predefined action. The predefined action may be any type of action that the evaluator intentionally performs to evaluate the evaluation target 11 as long as it is distinguishable from an unconscious action of the evaluator. Examples of the predefined action may include moving the evaluation device 12 in the air (i.e., gesture), a voice input to the evaluation device 12, and an operation on the evaluation device 12.

(4) When the predefined action is detected, the evaluation device 12 transmits the ID to a server 13. The server 13 identifies the evaluation target 11 based on the ID and counts an evaluation count for the evaluation target 11. That is, the server 13 increases the evaluation count associated with an ID every time the ID is received. When the received ID is not registered in the server 13, the server 13 registers the received ID and sets the evaluation count of the ID at 1.

Accordingly, when the evaluation count associated with an ID is large, it means that the evaluation target 11 with the ID has been evaluated by a large number of evaluators. When “evaluating” the evaluation target 11 means to indicate that the evaluation target 11 is “good”, a large evaluation count indicates that the evaluation target 11 is positively evaluated by many evaluators.

Thus, an evaluation system of the present embodiment allows an evaluator to actively evaluate products and services in the real world. Also according to the present embodiment, the server 13 may be configured to publish evaluation counts of the evaluation targets 11. This configuration enables an evaluator to view evaluation counts of the evaluation targets 11 evaluated by other evaluators. The evaluation system of the present embodiment also allows an evaluator to evaluate an evaluation target 11 after purchasing the evaluation target 11.

### <Configuration>

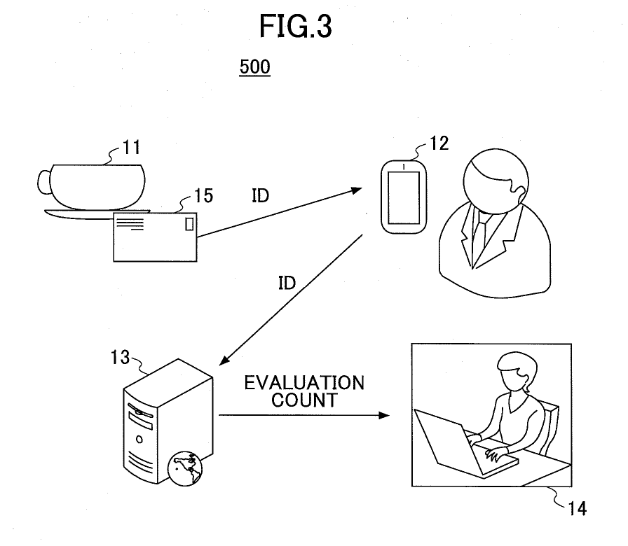

FIG. 3 is a schematic diagram illustrating an exemplary configuration of an evaluation system 500 of the first embodiment. The evaluation system 500 may include an evaluation target 11 (radio communication chip 15), an evaluation device 12, and a server 13. The evaluation system 500 may also include a browsing client 14. Here, any person or a qualified/certified person carrying the evaluation device 12 is referred to as an “evaluator”.

### <Evaluation Target and Radio Communication Chip>

The radio communication chip 15 is, for example, placed beside, placed on, attached to, or embedded in the evaluation target 11. The radio communication chip 15 may be, for example, an IC tag that employs the Radio Frequency Identification (RFID) technology. An IC tag may include a relatively-small chip and a relatively-small antenna, and may at least store an ID. When receiving a radio signal or an electromagnetic wave, the IC tag automatically retrieves and transmits the ID. In the present embodiment, the radio communication chip 15 may be equated with the evaluation target 11. However, the radio communication chip 15 and the evaluation target 11 may not necessarily be physically combined and inseparable.

The radio communication chip 15 may be produced through, for example, a semiconductor manufacturing process and have a three-dimensional shape. The radio communication chip 15 with a three-dimensional shape may be attached to or embedded in a surface of a three-dimensional or a planar object. The radio communication chip 15 may also be formed by a printing technology and have a planar (or two-dimensional) shape. Examples of printing technologies may include, but are not limited to, screen printing, flexographic printing, and inkjet printing. The radio communication chip 15 with a planar (or two-dimensional) shape may be directly formed on a surface of a three-dimensional or a planar object, or may be attached to the surface after being formed by printing.

The radio communication chip 15 may be implemented by any type of IC tag such as a passive IC tag that includes no battery, an active IC tag that includes a battery and actively (voluntarily) transmits a radio signal, or a semi-passive IC tag that includes a battery but does not actively transmit a radio signal. Also, the radio communication chip 15 may be configured to use any radio-frequency band. For example, various radio frequency bands such as a frequency band of 135 kHz or lower, a 13.56 MHz band, a UHF band (860-960 MHz), and a 2.45 GHz band are defined by respective countries and regions. Further, the radio communication chip 15 may be implemented by an IC tag conforming to a specific standard such as Near Field Communication (NFC) or TransferJet (registered trademark).

For example, a radio communication chip 15 implemented by an active or semi-passive IC tag may have a communication range of about 100 meters. Also, even a radio communication chip 15 implemented by a passive IC tag that communicates using the UHF band may have a communication range of 10 meters or greater. These types of radio communication chips 15 are preferable to evaluate the evaluation target 11 that is located at a distance from the evaluator. On the other hand, a radio communication chip 15 implemented by an IC tag that communicates using the 13.56 MHz band has a short communication range of several centimeters. This type of radio communication chip 15 is suitable for a case where the evaluator selects an evaluation target 11 from a large number of evaluation targets and evaluate the selected evaluation target 11.

The ID stored in the radio communication chip 15 is identification information and may be represented by numerals, symbols, alphabetical characters, or a combination of them. Known product ID code systems include Japanese Article Number (JAN) code, European Article Number (EAN) code, and Universal Product Code (UPC). The ID is preferably unique within the entire world, a country, or a region. However, because the ID is assigned to the evaluation target 11 by its provider, duplicate IDs may be used depending on the size of the evaluation system 500. For this reason, an IC tag may store not only an ID but also information on the evaluation target 11. Any information such as a product name, a provider name, a product size, color, and a lot number may be stored in an IC tag to facilitate the management of the evaluation target 11 (hereafter, this information may be referred to as “management information”). Accordingly, it is unlikely that both the ID and the management information stored in an IC tag match those stored in another IC tag. When a received ID matches two or more registered IDs, the server 13 determines whether the management information associated with the received ID matches management information associated with each of the matching IDs. If the management information associated with the received ID does not match the management information associated with the matching ID, the server 13 determines that the matching ID is assigned to a different evaluation target 11. In such a case, the server 13 may attach, for example, suffix numbers to duplicate IDs to make the IDs unique to the respective evaluation targets 11.

On the other hand, when the evaluation system 500 is used in a limited area such as an exhibition hall or a department store, evaluation counts are obtained only in the limited area and therefore IDs need to be unique only within the limited area.

The radio communication chip 15 may also be implemented by a device other than an IC tag, such as a Bluetooth (registered trademark) device or a wireless LAN device.

Any tangible or intangible object may serve as the evaluation target 11 as long as it is provided with the radio communication chip 15. Examples of tangible evaluation targets 11 may include a product, an exhibit, a rental product, belongings of one's own and other people, a stationary object, waste product, an object fixed onto a road, and a building. Examples of intangible evaluation targets 11 may include a service, a tourist spot, scenery, a place, and a space. Such an intangible evaluation target 11 may be associated with a tangible object provided with the radio communication chip 15 so that it can be evaluated. Examples of services and service providers may include a restaurant, a beauty parlor, cleaning, repair, recruiting, education, transportation, infrastructure, administrative services at a ward office and a city hall, and a medical institution. A service provider may place the radio communication chip 15, for example, in a service providing location, on a shop name, on a table in a shop, on a checkout counter, or on a clerk's terminal. When the evaluation target 11 is a tourist spot, scenery, a place, or a space, the radio communication chip 15 may be placed, for example, in a nearby station, at a bus stop, or on a guideboard of a tourist spot.

### <Evaluation Device>

The evaluation device 12 may be implemented by any device that includes a communication unit for communicating with the radio communication chip 15 and the server 13. For example, the evaluation device 12 may be implemented by a portable device such as a smartphone, a tablet, a straight PC, a cell phone, a personal digital assistant (PDA), or a notebook PC. Using such a portable device as the evaluation device 12 eliminates the need for the evaluator to carry an extra device dedicated to evaluating the evaluation targets 11. Also, the evaluation device 12 preferably has a shape that enables the evaluator to easily perform a predefined action to evaluate the evaluation target 11. For example, when the evaluation device 12 is shaped like a baton, the evaluator can evaluate the evaluation target 11 by just swinging the evaluation device 12 down. Also, the evaluation device 12 may be implemented by a name tag given to a visitor at, for example, an exhibition.

The evaluation device 12 periodically searches for a radio communication chip 15. When a radio communication chip 15 is detected, the evaluation device 12 receives an ID from the detected radio communication chip 15. The radio communication chip 15 may be configured to record an event of transmitting the ID.

When a predefined action is detected after receiving the ID, the evaluation device 12 transmits the ID to the server 13. On the other hand, when the predefined action is not detected after receiving the ID, the evaluation device 12 discards the ID.

As another example of a communication procedure, the evaluation device 12 may be configured to search for a radio communication chip 15 when the predefined action is detected, and to receive an ID from a detected radio communication chip 15. In this case, the evaluation device 12 transmits the ID to the server 13 when the ID is received.

The evaluation device 12 is preferably configured to store or retain the ID transmitted to the server 13. This configuration enables the evaluator carrying the evaluation device 12 to enter the ID of an evaluated evaluation target 11 into the browsing client 14 and thereby view the evaluation count of the evaluated evaluation target 11. Also, the evaluator may operate the evaluation device 12 to access the server 13 and view the evaluation count of the evaluated evaluation target 11.

The evaluation device 12 executes a program 114 (application) described later to perform processes according to the present embodiment. The program 114 may be downloaded from the server 13 or a file server being managed by the server 13.

### <Server>

The evaluation device 12 communicates with the server 13 via a network. The network may be implemented by a combination of a wireless network such as a cell phone network, a wireless LAN, or a WiMAX network and an IP network (a network where communications are performed using the Internet protocol). For example, in the network, a gateway of the cell phone network or the WiMAX network is connected to the IP network, or an access point of the wireless LAN is connected via a router to the IP network. The evaluation device 12 may be connected to a base station in the cell phone network or the WiMAX network and communicate via the gateway with the server 13. Also, the evaluation device 12 may be connected to the access point of the wireless LAN and communicate via the access point and the router with the server 13.

An IP address of the server 13 may be registered beforehand in the program 114 to be executed by the evaluation device 12. A global IP address may be assigned beforehand to the evaluation device 12, or a temporary local IP address may be assigned to the evaluation device 12 by the base station or the access point.

The server 13 may include two functions. A first function (which is hereafter referred to as a counting function 21) is for counting evaluation counts and a second function (which is hereafter referred to as a providing function 22) is for providing the evaluation counts to the browsing client 14. The evaluation count may be obtained by counting the number of times an ID is received. Also, each event of receiving an ID may be weighted (e.g., one event of receiving an ID may be counted as two, or counted as two or more depending on the strength of the gesture) and the weighted values may be totaled.

The providing function 22 provides the evaluation counts to the browsing client 14. The browsing client 14 may be implemented by an information processing apparatus. Also, the evaluation device 12 may be configured to function as the browsing client 14. The browsing client 14 is connected to the server 13 via a network. For example, the browsing client 14 receives an evaluation count from the server 13 and displays the received evaluation count via a browser. Also, the browsing client 14 may receive and display an evaluation count transmitted from the server 13 via an email message. The uniform resource locator (URL) or the IP address of the server 13 may be known to the browsing client 14 or may be provided by a domain name server (DNS) to the browsing client 14.

When the evaluation device 12 functions as the evaluation client 14, the evaluation device 12 can receive an evaluation count in response to an ID transmitted to the server 13. In this case, the program 114 running on the evaluation device 12 controls communications with the server 13.

Thus, a user (viewer) of the browsing client 14 can determine an evaluation target 11 that is highly evaluated and view the evaluation result of an evaluation target 11 that the user has evaluated. Also, because the provider of an evaluation target 11 knows or can at least obtain the ID of the evaluation target 11, the provider can view the evaluation count of the evaluation target 11 by entering the ID into the browsing client 14.

### <Hardware Configuration>

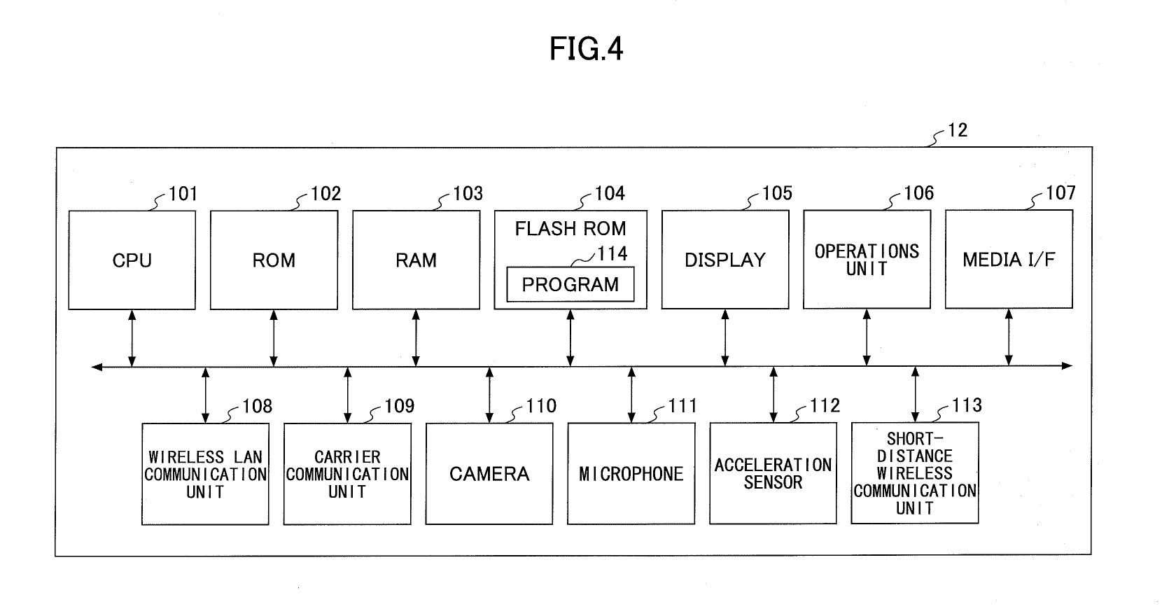

FIG. 4 is a block diagram illustrating an exemplary hardware configuration of the evaluation device 12. The evaluation device 12 may include a central processing unit (CPU) 101, a read-only memory (ROM) 102, a random access memory (RAM) 103, a flash ROM 104, a display 105, an operations unit 106, a media I/F (interface) 107, a wireless LAN communication unit 108, a carrier communication unit 109, a camera 110, a microphone 111, an acceleration sensor 112, and a short-distance wireless communication unit 113.

The CPU 101 executes the program 114 stored in the flash ROM 104 and thereby controls operations of the entire evaluation device 12. The ROM 102 stores, for example, an initial program loader (IPL) and static data. The RAM 103 is used as a work area by the CPU 101 when executing the program 114.

The flash ROM 104 stores, for example, an operating system (OS) (e.g., Android (registered trademark), iOS (registered trademark), or Windows (registered trademark)), middleware, and the program 114 that are to be executed by the CPU 101. The program 114 may also be referred to as an “application”.

The display 105 displays user interface (UI) screens and may be implemented by, for example, a liquid-crystal display, an organic light emitting (EL) display, or a projector. A graphics controller (not shown) of the evaluation device 12 interprets draw commands written into a video RAM by the CPU 101 and causes the display 105 to display various types of information such as windows, menus, a cursor, characters, and images. The display 105 may include a touch panel and may be configured to display software keys for receiving user inputs (or operations).

The operations unit 106 receives operations (or inputs) by the evaluator (or user) and may be implemented by hardware keys, a touch panel, or software keys displayed on a touch panel. The operations received via the hardware keys, the touch panel, or the software keys are reported to the CPU 101.

The media I/F 107 controls reading and writing (or storing) of data from and to a storage medium such as a flash memory.

The program 114 is an installable and executable file and may be stored in a non-transitory computer-readable storage medium for delivery. Also, the program 114 may be downloaded as an installable and executable file from the server 13 and installed into the evaluation device 12.

The wireless LAN communication unit 108, for example, controls the modulation scheme, the transmission rate, and the frequency, and transmits and receives data according to IEEE 802.11b/11a/11g/11n. When receiving data, the wireless LAN communication unit 108 converts a received radio signal into a digital signal. Meanwhile, when transmitting data requested by the CPU 101, the wireless LAN communication unit 108 modulates the data according to a communication standard and transmits the modulated data as a radio signal.

The carrier communication unit 109 performs various communications depending on a telecommunications carrier to which the user (evaluator) of the evaluation device 12 subscribes. Examples of telecommunications carriers include a cell-phone operator providing communication services according to a communication standard such as Code-Division Multiple Access (CDMA) or Long Term Evolution (LTE) and a WiMAX operator. A subscriber identify module (SIM) card is attached to the carrier communication unit 109. The SIM card is an IC card that stores subscriber information issued by a telecommunications carrier for a subscriber. The subscriber information may include a unique number called an international mobile subscriber identify (IMSI) and a cell phone number.

The carrier communication unit 109, for example, modulates signals according to a communication scheme defined by the telecommunications carrier and communicates with a base station (not shown) connected to the Internet. The base station is connected to a carrier server of the telecommunications carrier. The carrier server assigns a temporary IP address to the evaluation device 12 and transmits an ID received from the evaluation device 12 via a gateway to the IP network.

The camera 110 is a color imaging unit including a photoelectric conversion element such as a charge-coupled device (CCD) or a complementary metal-oxide semiconductor (CMOS) device. When the camera 110 is implemented by a stereo camera or includes a distance measuring function, it is possible to determine the distance between the camera 110 (or the evaluation device 12) and the evaluation target 11, and to estimate the size of the evaluation target 11 based on the focal length of a lens of the camera 110. This in turn makes it possible to identify the evaluation target 11 based on an image of the evaluation target 11 obtained by the camera 11.

The microphone 111 captures the voice of the evaluator and converts the captured voice into a electric signal. The program 114 running on the evaluation device converts the electric signal into text data, i.e., performs voice recognition.

The acceleration sensor 112 detects the acceleration of the evaluation device 12 in the x-axis, y-axis, and z-axis directions. The acceleration sensor 112 is used to detect, for example, the orientation of the evaluation device 12 and the moving direction of the evaluation device 12 in space. The evaluation device 12 may also include a gyro sensor, a geomagnetic field sensor, and a fingerprint sensor. The gyro sensor detects the angular velocity of the evaluation device 12 with respect to the x-axis, the y-axis, and the z-axis. The geomagnetic field sensor detects the direction of the evaluation device 12 based on the direction of the geomagnetic field. By combining detection results from these sensors, it is possible to detect a complex predefined action.

The short-distance wireless communication unit 113 performs RFID communications with the radio communication chip 15. When the radio communication chip 15 is a passive IC tag, communications are performed as described below. The short-distance wireless communication unit 113 transmits a radio signal within a predetermined range. The radio signal includes a control signal (or a command) for controlling the radio communication chip 15. When the radio signal is received, the antenna of the radio communication chip 15 resonates with the radio signal, power is generated by a resulting electromotive force, the circuit of the radio communication chip 15 is activated by the generated power, and the circuit performs a process according to the control signal (i.e., retrieves and transmits the ID). The radio communication chip 15 modulates a carrier wave with a predetermined frequency based on the ID and transmits the modulated carrier wave as a radio signal.

The short-distance wireless communication unit 113 demodulates the radio signal and extracts the ID.

The short-distance wireless communication unit 113 may be implemented by a Bluetooth (registered trademark) device or an ultrawideband device that includes an RFID communication function.

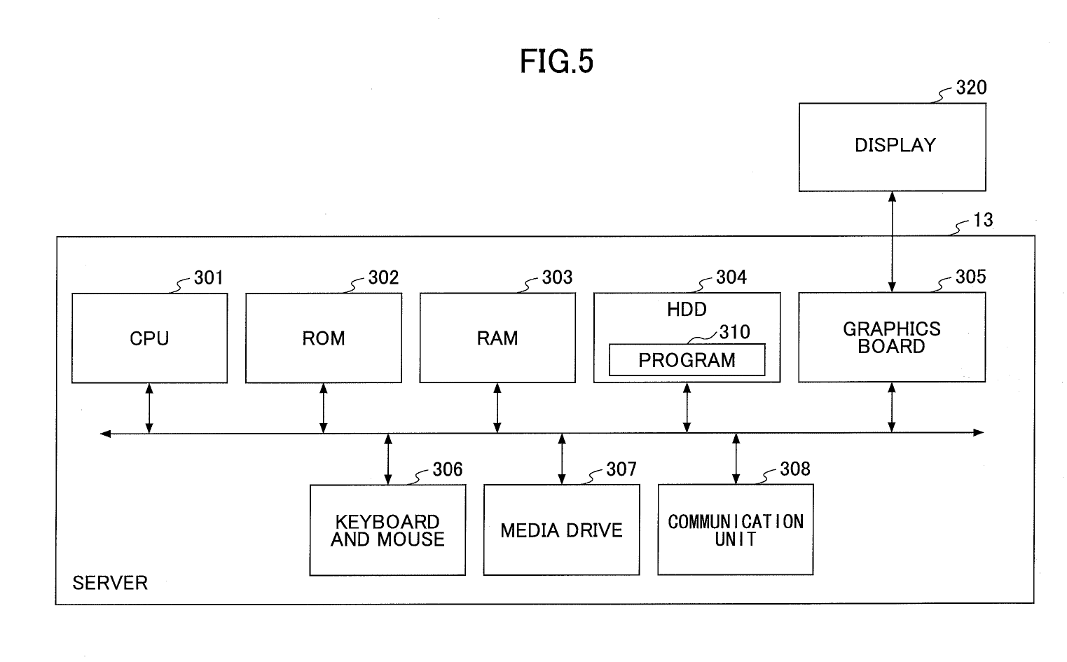

FIG. 5 is a block diagram illustrating an exemplary hardware configuration of the server 13. The server 13 may be implemented by an information processing apparatus with a general configuration.

The server 13 may include a CPU 301, a ROM 302, a RAM 303, a hard disk drive (HDD) 304, a graphics board 305, a keyboard-and-mouse 306, a media drive 307, and a communication unit 308. The CPU 301 executes a program 310 stored in the HDD 304 using the RAM 303 as a working memory and thereby controls the entire server 13. The keyboard-and-mouse 306 is an input device for receiving inputs (or operations) from a system administrator. The media drive 307 reads and writes data from and to optical media such as a compact disk (CD), a digital versatile disk (DVD), and a Blu-ray disk. The communication unit 308 is implemented, for example, by an Ethernet (registered trademark) card for connecting the server 13 to a network.

The HDD 304 stores, for example, an OS (e.g., Windows (registered trademark) or Linux (registered trademark)), middleware, and the program 310 that provides the counting function 21 and the providing function 22. The program 310 is an installable and executable file and may be stored in a non-transitory computer-readable storage medium for delivery. Also, the program 310 may be downloaded as an installable and executable file from another server (not shown) and installed into the server 13.

The browsing client 14 may have a hardware configuration similar to that of the server 13.

### <Functional Configuration>

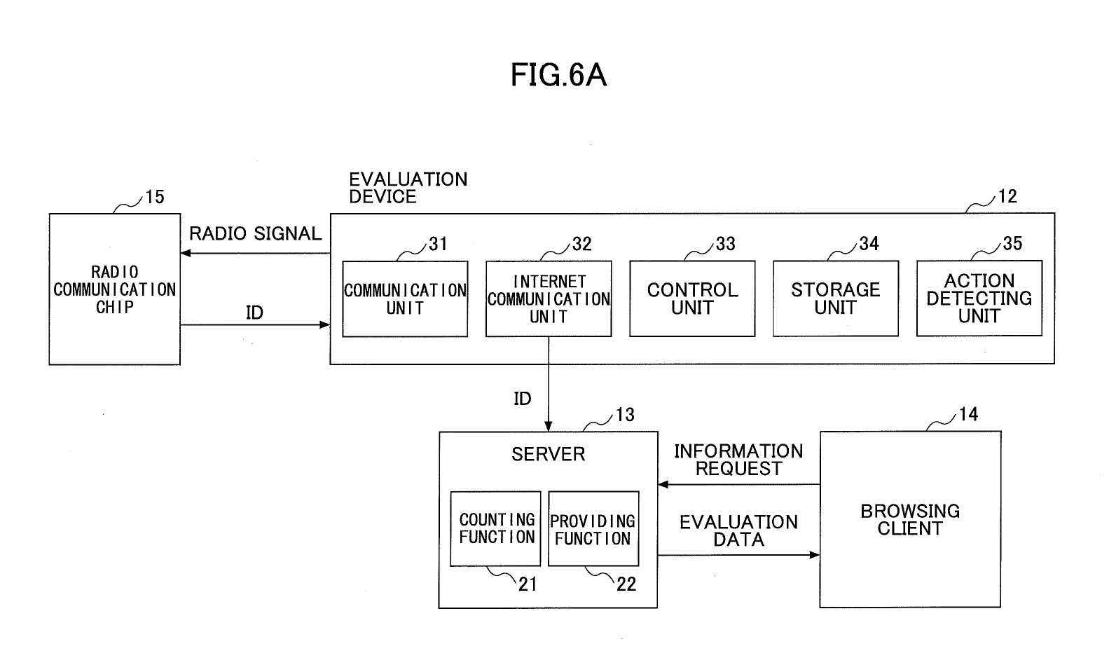

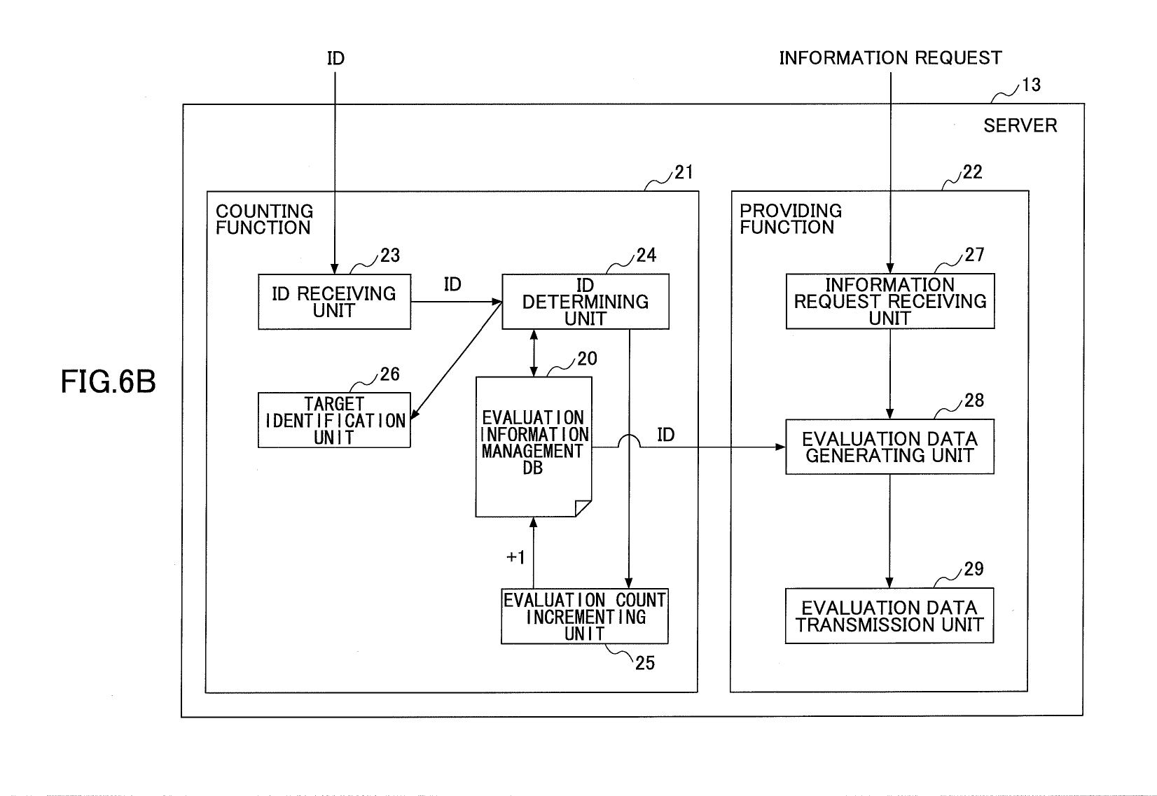

FIG. 6 is a block diagram illustrating an exemplary functional configuration of the evaluation system 500. The evaluation device 12 may include a communication unit 31, an internet communication unit 32, a control unit 33, a storage unit 34, and an action detecting unit 35. The control unit 33 controls operations of the evaluation device 12. The control unit controls the communication unit 31 and the internet communication unit 32 according to a predetermined procedure to receive an ID from the radio communication chip 15 and transmit the ID to the server 13. The internet communication unit 32 can receive an evaluation count from the server 13.

### <Evaluation Device>

The communication unit 31 controls the short-distance wireless communication unit 113 to obtain an ID from the radio communication chip 15. The internet communication unit 32 controls the carrier communication unit 109 or the wireless LAN communication unit 108 according to an application layer protocol such as the File Transfer Protocol (FTP) or the Hypertext Transfer Protocol (HTTP) to communicate with the server 13 and transmit the ID to the server 13.

When a plurality of evaluation targets 11 are present within the communication range of the communication unit 31, IDs may be received from a plurality of radio communication chips 15 within a short period of time. In such a case, IDs transmitted from the internet communication unit 32 to the server 13 may be determined according to one of the following methods:

All IDs are transmitted.

Last ID is transmitted.

Selected ID is transmitted.
Highest-intensity ID having the highest signal intensity is transmitted.

All IDs may be transmitted when it is appropriate to collectively evaluate multiple evaluation targets 11. For example, this applies to a case where the evaluation targets 11 are a series of daily necessities or interior goods having uniform design. The last ID indicates an ID that has been received most recently and after which no ID has been received for a predetermined period of time (i.e., an ID that has been received immediately before the reception of IDs stops). When the evaluator finds an interesting evaluation target 11 while walking around, the evaluator may stop in front of the found evaluation target 11. Therefore, it is likely that the last ID is the ID of the found evaluation target 11. Accordingly, transmitting the last ID makes it possible to transmit the ID of an evaluation target 11 that has been evaluated by the evaluator to the server 13.

The selected ID indicates one of received IDs selected by the evaluator.

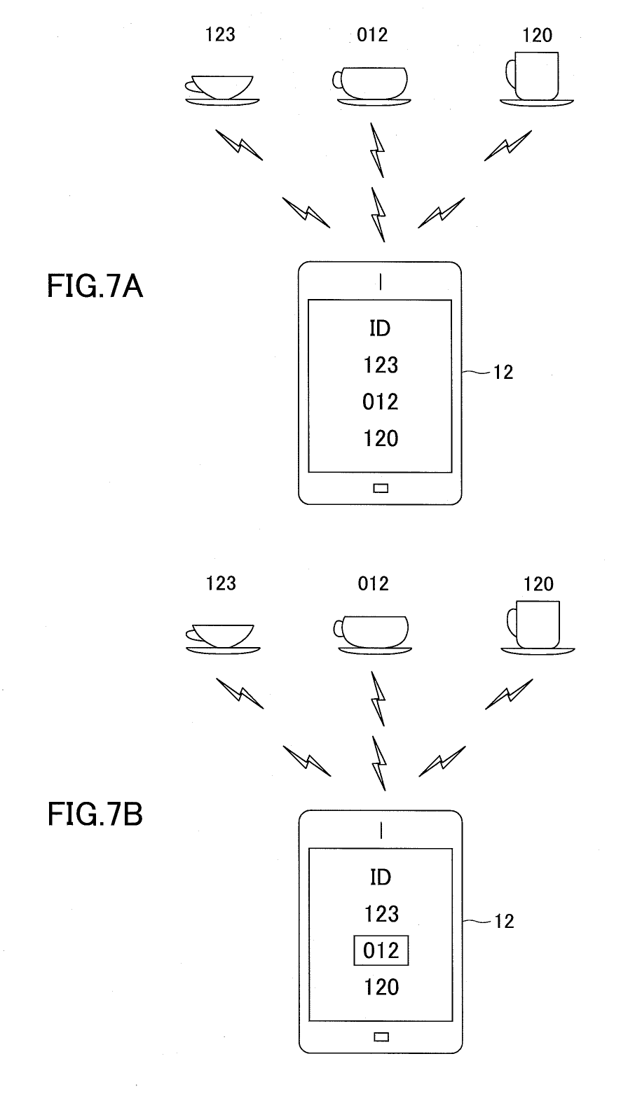

FIG. 7A illustrates exemplary IDs received by the communication unit 31 and displayed on the display 105. In FIG. 7A, it is assumed that three evaluation targets 11 (in this example, cups) exist in the communication range and IDs of the evaluation targets 11 are displayed on the display 105. In this case, the evaluator causes the evaluation device 12 to communicate again with one or more evaluation targets 11 and thereby identifies the ID of an evaluation target 11 that the evaluator intends to evaluate. When the short-distance wireless communication unit 113 has directivity, an ID is returned from an evaluation target 11 at which the evaluation device 12 is directed. Thus, the evaluator can identify the ID of an intended evaluation target 11 by directing the evaluation device 12 at the intended evaluation target 11. Also, when the radio communication chip 15 is configured to also transmit management information such as a product name to the evaluation device 12, the evaluation device 12 displays the management information on the display 105 together with the ID. This configuration makes it easier for the evaluator to identify the ID of an intended evaluation target 11.

The highest-intensity ID is the ID of an evaluation target 11 that is closest to the evaluation device 12. FIG. 7B illustrates exemplary IDs displayed on the display 105, where one of the IDs with the highest signal intensity is marked. The communication unit 31 can identify the ID of a radio communication chip 15 whose signal intensity is the highest. For example, the evaluation device 12 surrounds the ID with a rectangular frame or highlights the ID. When the evaluator is interested in a particular evaluation target 11, the evaluator naturally come close to the evaluation target 11. Therefore, this method also makes it possible to transmit the ID of an intended evaluation target 11 to the server 13.

Also, the internet communication unit 32 (or the control unit 33) may be configured to transmit the ID of the radio communication chip 15 with the highest signal intensity to the server 13 without requesting the evaluator to select the ID.

In some cases, it is preferable to transmit information on the evaluation target 11 in addition to the ID to the server 13. For example, when the ID of an evaluation target 11 is not registered in the server 13 or a different evaluation target 11 is registered in association with the same ID, the server 13 cannot identify the evaluation target 11 based only on the ID. For this reason, the communication unit 31 may be configured to transmit related information related to the evaluation target 11 together with the ID.

The related information may include the management information received from the radio communication chip 15, a unique number of the evaluation device 12, positional information of the evaluation device 12, time information, a moving direction of the evaluator, an image of the evaluation target 11, and a comment on the evaluation target 11 entered by the evaluator. The management information received from the radio communication chip 15 includes various information items as described above for facilitating the management of the evaluation target 11. The unique number is, for example, an IMSI or a cell phone number. The positional information may be detected by a Global Navigation Satellite Systems (GNSS) device included in the evaluation device 12. Also, the positional information may be calculated based on the intensity of signals from multiple base stations and the positions of the base stations. The moving direction indicates one of the north, south, east, and west directions and may be identified based on a time series of positional information or a detection result of the geomagnetic field sensor. The image of the evaluation target 11 is captured by the camera 110. The comment is entered by the evaluator into the evaluation device 12 and may include, for example, the name of the evaluation target 11 and detailed evaluation results.

When the evaluation system 500 is used in a limited area such as an exhibition hall or a department store, the related information may include personal information that the evaluator agreed to transmit to the server 13. The personal information may include contact information such as a company name, an evaluator name, an address, a phone number, and an email address. Particularly in an exhibition, it often happens that the evaluator is interested in an evaluation target 11 and wishes to obtain detailed information on the evaluation target 11. Also, providers of products and services may want to contact evaluators who are interested in their products and services. The personal information may be used in such cases.

The storage unit 34 stores the ID received by the communication unit 31. Preferably, the storage unit may also store positional information and time information at which the ID is received. Further, when an image of the evaluation target 11 is taken by the evaluator using the camera 110, the storage unit 34 also stores the image.

The action detecting unit 35 detects a predefined action based on, for example, the acceleration of the evaluation device 12 detected by the acceleration sensor 112, and reports the detection of the predefined action to the control unit 33. Here, a predefined action detected via the acceleration sensor 112 is referred to as a “gesture”. For example, the action detecting unit 35 may be configured to detect a gesture where the evaluation device 12 is moved (or waved) vertically. In this case, the action detecting unit 35 determines that the gesture is detected when alternating (or continuously changing) downward and upward acceleration is detected by the acceleration sensor 112. Also, the predefined action may be defined as a gesture where the evaluation device 12 is moved upward and downward a predetermined number of times, a gesture where the evaluation device 12 is moved rightward and leftward a predetermined number of times, or a gesture where the evaluation device 12 is thrust forward. The acceleration sensor 112 detects changes in the acceleration corresponding to a gesture performed. The action detecting unit 35 may be configured to store a pattern of changes in the acceleration that is typical of the predefined action (gesture) and compare the detected changes in the acceleration with the stored pattern of changes in the acceleration to detect the predefined action.

The predefined action is not limited to a gesture. For example, the predefined action may be a voice input or an operation (or input) on the hardware keys, the software keys, or the touch panel of the evaluation device 12.

Also, the predefined action may be defined as taking a picture. Further, a combination of a gesture and a voice input or an operation on the evaluation device 12 may be used as a condition for transmitting the ID to the server 13.

The action detecting unit 35 may also be configured to distinguish between a predefined action indicating a positive evaluation and a predefined action indicating a negative evaluation. In this case, the action detecting unit 35 may store a pattern of changes in the acceleration corresponding to the predefined action indicating a positive evaluation and a pattern of changes in the acceleration corresponding to the predefined action indicating a negative evaluation, and compare the detected changes in the acceleration with the stored patterns of changes in the acceleration to determine one of the predefined actions.

### <Server>

The counting function 21 of the server 13 may include an ID receiving unit 23, an ID determining unit 24, an evaluation count incrementing unit 25, a target identification unit 26, and an evaluation information management database (DB) 20. The evaluation information management DB 20 may instead be provided outside of the server 13 as long as it is accessible from the server 13.

The ID receiving unit 23 receives an ID and if available, also related information from the evaluation device 12. The ID determining unit 24 identifies the evaluation target 11 based on the ID. Here, as described above, there are cases where the evaluation target 11 can be identified based only on the ID and where the evaluation target 11 cannot be identified based only on the ID. For example, when IDs are assigned only to evaluation targets 11 registered beforehand in the server 13, the ID determining unit 24 can uniquely identify the evaluation targets 11 based on the IDs. This applies, for example, to a case where the evaluation system 500 is used in a limited area such as an exhibition hall or a department store. On the other hand, in a case where various providers freely assign IDs to evaluation targets 11 without the involvement of the server 13, it may be difficult to identify the evaluation targets 11 based only on the IDs. This is because there is a chance that some IDs are not registered in the server 13 or duplicate IDs are assigned to the evaluation targets 11.

When the received ID matches an ID registered in the evaluation information management DB 20, the ID determining unit 24 reports the matching ID to the evaluation count incrementing unit 25. When the received ID matches two or more IDs registered in the evaluation information management DB 20, the ID determining unit 24 selects one of the IDs based on the related information and reports the selected ID to the evaluation count incrementing unit 25.

When the received ID matches none of IDs registered in the evaluation information management DB 20, the ID determining unit 24 newly registers the received ID in the evaluation information management DB 20 and reports the registered ID to the evaluation count incrementing unit 25. The evaluation count of the newly-registered ID is set at 0.

The ID determining unit 24 may also be configured to refer to the unique number of the evaluation device 12 in the related information, and to discard the received ID when the ID has already been received from the same evaluation device 12. This configuration makes it possible to prevent the same evaluation target 11 from being repeatedly evaluated by the same evaluator.

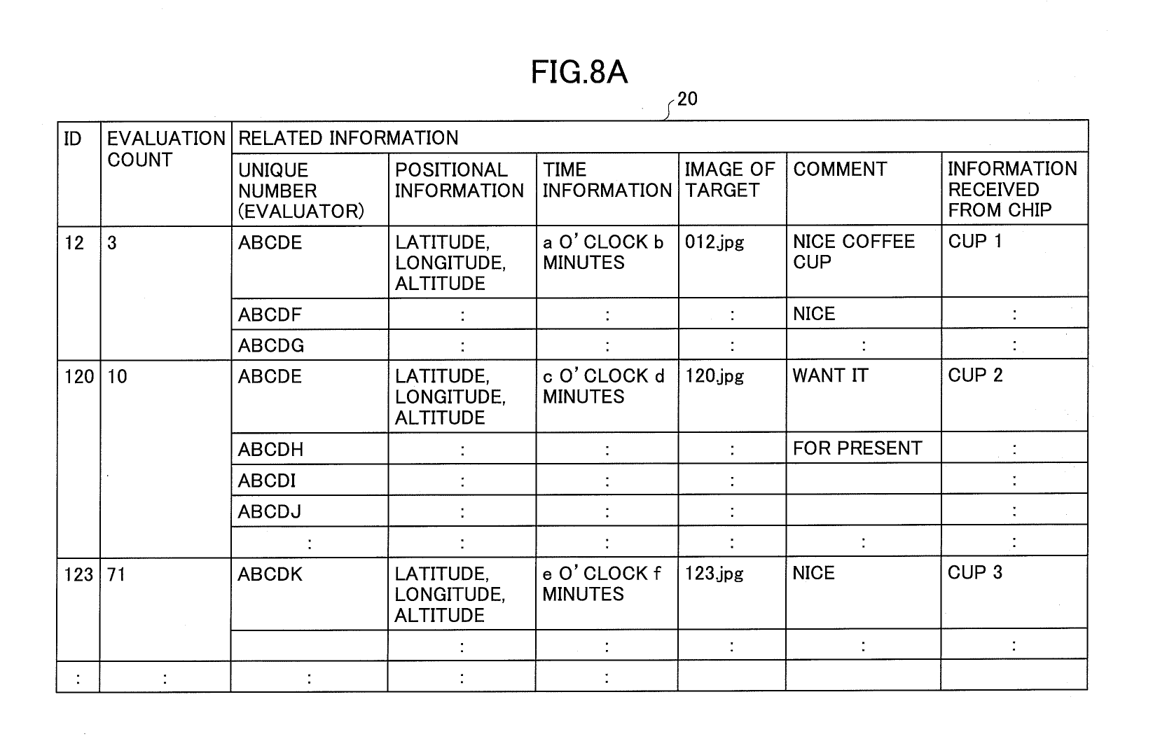

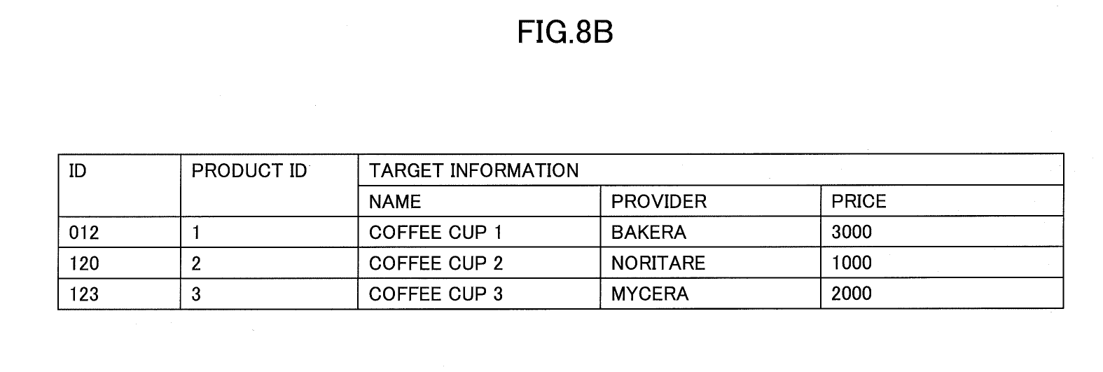

FIG. 8A is an example of an evaluation result table stored in the evaluation information management DB 20. In the example of FIG. 8A, each ID is associated with an evaluation count and related information. The evaluation count is incremented by the evaluation count incrementing unit 25, basically, by 1. The related information, as described above, includes a unique number, positional information, time information, an image of the evaluation target 11, a comment, and the management information received from the radio communication chip 15.

In FIG. 8A, it is assumed that transmission of an ID indicates a positive evaluation of the evaluation target 11 and the evaluation count represents the number of times that the evaluation target 11 is positively evaluated. When negative evaluations are also counted, two types of evaluation counts such as “positive evaluation count” and “negative evaluation count” may be recorded in the evaluation result table.

The server 13 is preferably configured to be able to identify the evaluation target 11 that has been evaluated. For this purpose, the server 13 may include a target identification table.

FIG. 8B is an example of a target identification table stored in the evaluation information management DB 20. In the example of FIG. 8B, each ID is associated with a product ID and target information. When the evaluation system 500 is used in a limited area such as an exhibition hall or a department store, it can be assumed that the correspondence between IDs and products and services (i.e., evaluation targets 11) is known, and information such as product IDs, names, providers, and prices of the evaluation targets 11 are available. The “product ID” is identification information used by the provider to identify a product. The product ID is at least unique within the provider managing the product ID. The “name” represents a product or service (e.g., coffee cup 1/2/3, or a name of a restaurant). The “provider” indicates, for example, a manufacturer or a seller of the evaluation target 11. The “price” indicates the price of a product or a service. The “price” is not essential. The target identification table may also contain generic names of products and services. With the target identification table, the browsing client 14 can obtain an evaluation count(s) by specifying, for example, the ID of an evaluation target 11, the name of the evaluation target 11, and/or a provider of the evaluation target 11.

When IDs are assigned to evaluation targets 11 without the involvement of the server 13, it is difficult to identify the evaluation targets 11 based only on the IDs. Therefore, the server 13 is preferably configured to construct the target information based on the related information.

When the ID determining unit 24 determines that a received ID of an evaluation target 11 matches none of IDs registered in the evaluation information management DB 20, the target identification unit 26 of the server 13 identifies the evaluation target 11 based on received related information. For example, the target identification unit 26 parses the comment in the related information to extract nouns, and searches a dictionary or a search engine with the extracted nouns to identify the name and the provider of the evaluation target 11.

Also, the program 114 of the evaluation device 12 may be configured to display a screen on the display 105 to allow the evaluator to enter information such as a name, a provider, and a price when a predefined action is detected by the action detecting unit 35. In this case, the target identification unit 26 can use the name, the provider, and the price entered by the evaluator and sent from the evaluation device 12 to correctly register the target information.

There is also a case where the radio communication chip 15 retains management information including a name, a provider, and a price and transmits the management information together with the ID to the evaluation device 12. In this case, the target identification unit 26 can identify the evaluation target based on the management information of the radio communication chip 15.

The target identification unit 26 may also be configured to identify, based on map data, a store located at a position indicated by the positional information in the related information, and thereby identify the name and the provider of the evaluation target 11. Because map data generally include store names (or provider names), a store name of a provider can be identified based on the positional information, and the name of a product or a service provided by the provider can be searched for based on the store name. Thus, it is possible to identify the name and the provider of the evaluation target 11 by entering the positional information or an address into a known search engine.

Further, the target identification unit 26 may be configured to identify the evaluation target 11 based on an image of the evaluation target 11. For example, the target identification unit 26 searches a database or the Internet using an image matching method as described in a second embodiment to find an image matching the image of the evaluation target 11, extracts a product name and a seller from text accompanying the found image, and identifies the name, provider, and price of the evaluation target 11 based on the extracted product name and seller. The target identification unit 26 identifies information on the evaluation target 11 as described above and registers the information in the target identification table.

When receiving an ID from the ID determining unit 24, the evaluation count incrementing unit 25 increments the evaluation count associated with the ID in the evaluation result table by 1. Accordingly, in this example, an evaluation target 11 receives a higher evaluation as the number of times that the ID has been received increases.

The providing function 22 of the server 13 may include an information request receiving unit 27, an evaluation data generating unit 28, and an evaluation data transmission unit 29. The information request receiving unit 27 receives, from the browsing client 14, an information request for requesting an evaluation count. For example, when the browsing client 14 accesses the server 13 using a browser, the information request receiving unit 27 transmits HTML data of a top page to the browsing client 14.

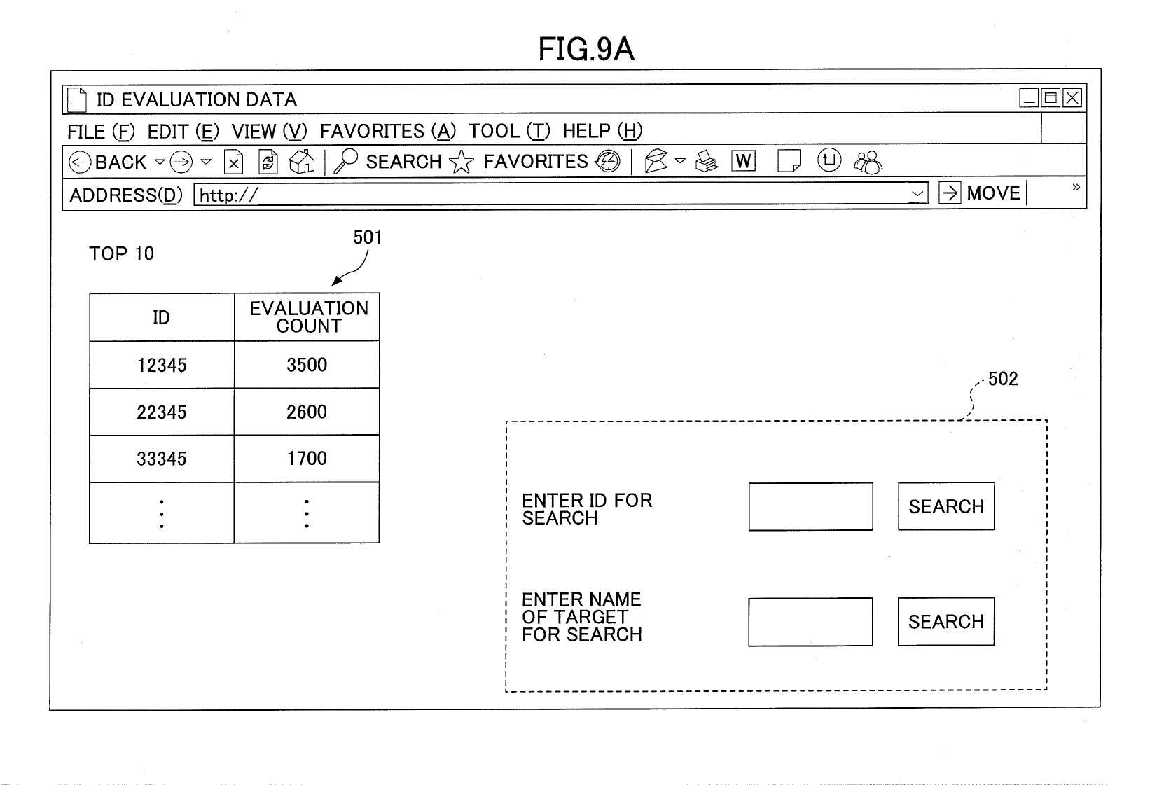

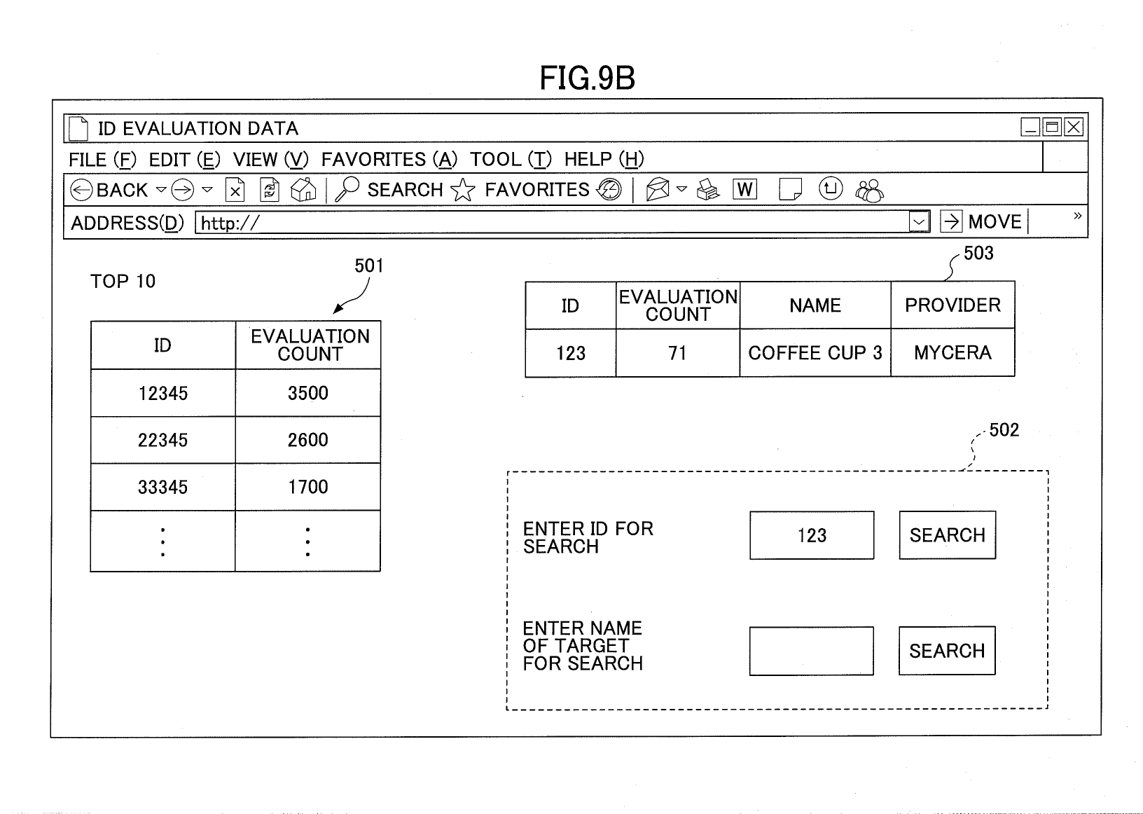

FIG. 9A is a drawing illustrating an exemplary top page displayed on the browsing client 14. The top page includes a high-ranking display area 501 and search area 502. The high-ranking display area 501 displays IDs and their evaluation counts in the top 10. The high-ranking display area 501 may also display product names corresponding to the IDs. The search area 502 allows the user (the evaluator or the viewer) to search the evaluation result table based on an ID and a name. An ID entry field is accompanied by a legend “ENTER ID FOR SEARCH”, and a name entry field is accompanied by a legend “ENTER NAME OF TARGET FOR SEARCH”. The search area 502 may also include a product ID entry field and a provider entry field. For example, when the product ID is known, the user of the browsing client 14 can retrieve and receive the evaluation count of the exact evaluation target 11 based on the product ID. Thus, the user of the browsing client 14 can search for an evaluation count of an evaluation target 11 by a desired method.

When the information request receiving unit 27 receives an ID or a name from the browsing client 14, the evaluation data generating unit 28 generates evaluation data. When an ID is received, the information request receiving unit 27 searches the evaluation result table based on the ID to find a record (row) including the ID, and retrieves the evaluation count from the found record. When the target information is available, the information request receiving unit 27 may also retrieve the corresponding target information. The evaluation data generating unit 28 generates evaluation data, which includes at least the ID and the evaluation count and may also include the target information, in, for example, an HTML format. Then, the evaluation data transmission unit transmits the generated evaluation data to the browsing client 14. When a product ID is received, the information request receiving unit 27 converts the product ID into a corresponding ID. The rest of the process is the same as that described above.

When a name is received, the information request receiving unit 27 searches the evaluation result table to find one or more records including IDs corresponding to the name, and retrieves the evaluation counts from the found records. The evaluation data generating unit 28 generates evaluation data, which includes at least the IDs and the evaluation counts and may also include the target information, in, for example, an HTML format.

The browsing client 14 can display the evaluation data as exemplified by FIG. 9B. In FIG. 9B, a search result area 503 is newly displayed on the top page. In this example, the search result area 503 displays the ID, the evaluation count, the name, and the provider. Thus, the browsing client 14 can display the evaluation count of an evaluation target 11 in the real world. The browsing client 14 can also display other information being managed by the server 13. For example, the browsing client 14 can display a comment, an image of the evaluation target 11, and a location (positional information) of the evaluation target 11.

The evaluation data generating unit 28 can process evaluation counts. For example, the evaluation data generating unit 28 can calculate an evaluation count for the last one hour based on the time information, calculate an evaluation count for each region based on the positional information, and calculate an evaluation count for each evaluator based on the unique number.

The operator of the evaluation system 500 may provide IDs, evaluation counts, related information, product IDs, and target information for a fee or for free. For example, when the evaluation system 500 is used for an exhibition or a department store, the operator of the evaluation system 500 may provide IDs and evaluation counts to exhibitors or stores in the department store. In this case, it is beneficial to also provide the related information, particularly the personal information of evaluators. With the provided information, the exhibitors or the stores in the department store can determine highly-evaluated evaluation targets 11 and contact the evaluators who are interested in the evaluation targets 11.

When the evaluation system 500 is applied to a social networking service (SNS) or a Web site, the SNS or the Web site can provide visitors with information on evaluation targets 11 that are highly-evaluated in the real world. This in turn makes it possible to increase the number of visitors to the SNS or the Web site and thereby increase the advertising revenue.

### <Evaluation Process>

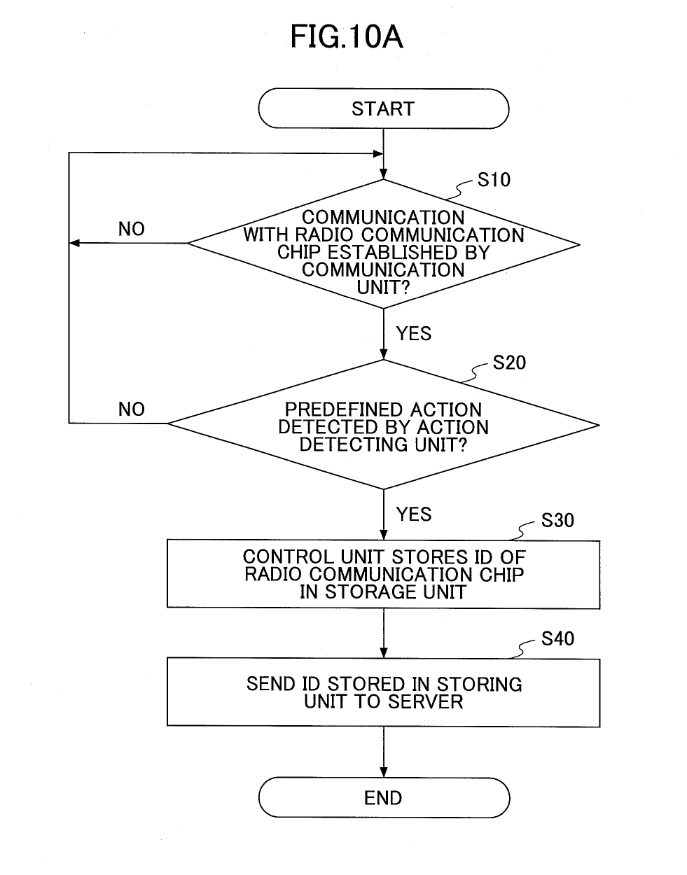

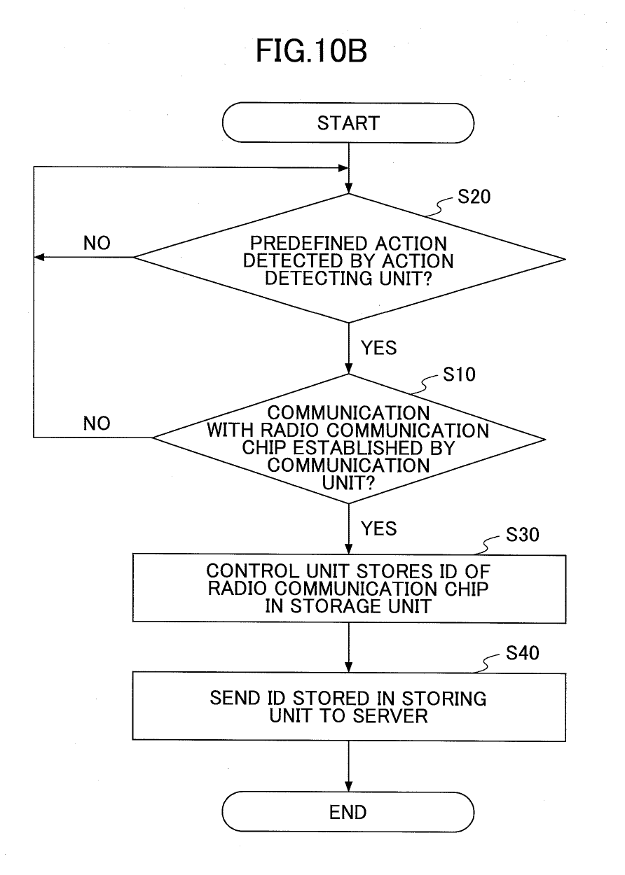

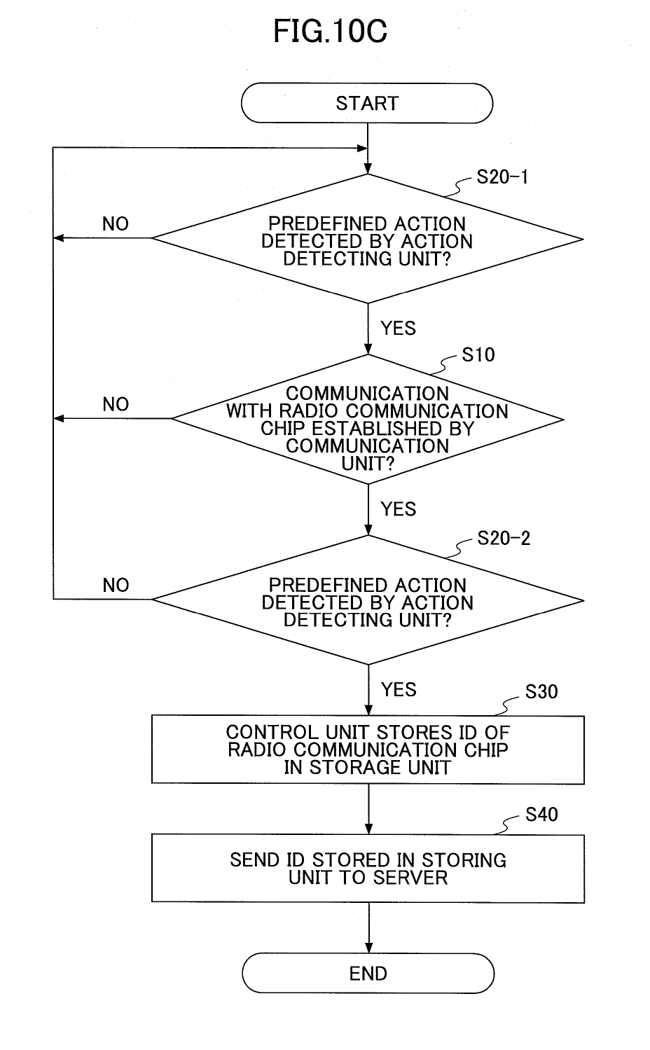

FIGS. 10A through 10C are flowcharts illustrating exemplary processes performed by the evaluation device 12 to evaluate the evaluation target 11. Any one of the exemplary processes may be employed by the evaluation device 12. Also, any other appropriate process may be employed by the evaluation device 12.

The process of FIG. 10A is described below. The process of FIG. 10A is repeatedly performed while the program 114 is being executed by the evaluation device 12.

The communication unit 31 establishes communication with the radio communication chip 15 (S10). Here, “establishing communication” indicates that the communication unit 31 and the radio communication chip 15 become able to communicate with each other, or the communication unit 31 and the radio communication chip 15 exchange their identification information to be able to transmit and receive data to and from each other. For example, the RFID may be used as a communication protocol. The communication unit 31 may be configured to determine that the communication has been established when an ID is received from the radio communication chip 15. The communication unit 31 periodically searches for a radio communication chip 15. When a radio communication chip 15 is present in the communication range, the communication unit 31 receives an ID from the radio communication chip 15. After the ID is received, the communication may be terminated, or may be maintained to repeatedly exchange information to confirm the presence of each other.

When communication is established and an ID is received, the evaluation device 12 may report the reception of the ID to the evaluator by, for example, playing music, generating vibration, or displaying a message or an icon on the display 105. This enables the evaluator to notice the reception of the ID and that it is now possible to evaluate the evaluation target 11.

When communication is established with the radio communication chip 15 (YES at S10), the control unit 33 determines whether a predefined action is detected by the action detecting unit 35 (S20). Details of this step is described later.

When the predefined action is detected by the action detecting unit 35 (YES at S20), the control unit 33 stores the ID of the radio communication chip 15 in the storage unit 34 (S30). In this step, related information is preferably stored in the storage unit 34 together with the ID.

When the communication unit 31 has communicated with a plurality of radio communication chips 15 and multiple IDs have been received, one of the IDs may be selected by the evaluator or the evaluation device 12 as described above and stored in the storage unit 34. Alternatively, all of the IDs may be stored in the storage unit 34.

The control unit 33 causes the internet communication unit 32 to transmit the ID stored in the storage unit 34 to the server 13 (S40). When it is difficult to transmit the ID due to, for example, poor signal conditions, the internet communication unit 32 transmits the ID stored in the storage unit 34 to the server 13 when or at a location where the signal conditions are good.

Next, the process of FIG. 10B is described. In FIG. 10B, different from FIG. 10A, the action detecting unit 35 detects the predefined action before communication is established.

In the process of FIG. 10B, when the predefined action is detected by the action detecting unit 35 (YES at S20), the control unit 33 requests the communication unit 31 to communicate with the radio communication chip 15.

When the communication unit 31 establishes communication with the radio communication chip 15 (YES at S10), the control unit 33 stores the ID of the radio communication chip 15 in the storage unit 34 (S30). Also in this case, the evaluation device 12 is preferably configured to report the reception of the ID to the evaluator by, for example, playing music.

The control unit 33 causes the internet communication unit 32 to transmit the ID stored in the storage unit 34 to the server 13 (S40).

The process of FIG. 10B eliminates the need for the communication unit 31 to continuously or periodically search for the radio communication chip 15 and thereby makes it possible to reduce power consumption. Also with the process of FIG. 10B, the reception of the ID is caused by the predefined action. Therefore, it is easier for the evaluator to determine whether the ID is received from an intended evaluation target 11.

In the process of FIG. 10C, multiple predefined actions are detected before the ID is transmitted to the server 13.

In FIG. 100, when a first predefined action is detected by the action detecting unit 35 (YES at S20-1), the control unit 33 requests the communication unit 31 to communicate with the radio communication chip 15. The first predefined action is, for example, a gesture.

When the communication unit 31 establishes communication with the radio communication chip 15 (YES at S10), the control unit 33 determines whether a second predefined action is detected by the action detecting unit 35 (S20-2). The second predefined action is, for example, an operation on the touch panel. When the second predefined action is detected by the action detecting unit 35 (YES at S20-2), the control unit 33 stores the ID of the radio communication chip 15 in the storage unit 34 (S30). Also in this case, the evaluation device 12 is preferably configured to report the reception of the ID to the evaluator by, for example, playing music.

Then, the control unit 33 causes the internet communication unit 32 to transmit the ID stored in the storage unit 34 to the server 13 (S40).

With the process of FIG. 10C, the evaluator can receive the ID by performing the first predefined action and transmit the ID by performing the second predefined action. This enables the evaluator to transmit the ID to the server 13 after confirming that the ID belongs to an evaluation target 11 that the evaluator intends to evaluate. The process of FIG. 10C also makes it possible to select an ID when multiple IDs are received as a result of the first predefined action.

### <Process of Detecting Predefined Action>

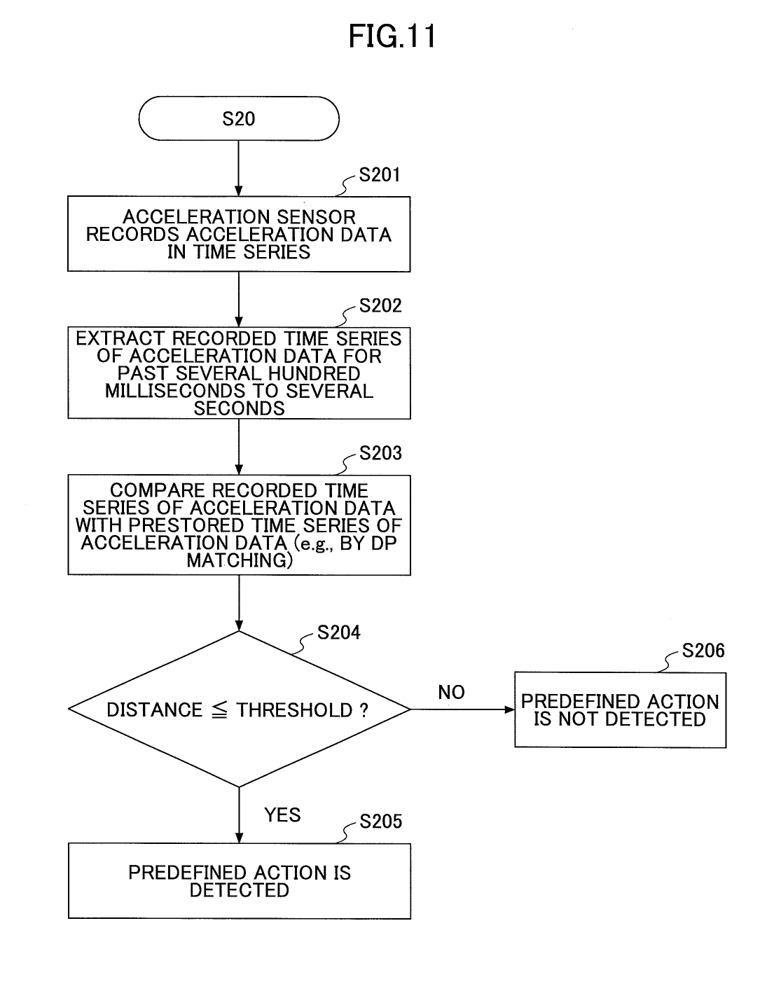

An exemplary process performed by the action detecting unit 35 to detect the predefined action (i.e., S20 or S20-1) is described below. Here, it is assumed that the predefined action is a gesture. FIG. 11 is a flowchart illustrating a process performed by the action detecting unit 35 to detect a gesture.

In FIG. 11, the acceleration sensor 112 records acceleration data of the evaluation device 12 in time series (S201).

The action detecting unit 35 extracts a recorded time series of acceleration data for past several hundred milliseconds to several seconds (S202).

The action detecting unit 35 compares the recorded time series of acceleration data with a typical time series of acceleration data that is prestored and typical of the predefined action (time series matching) (S203). For example, a dynamic programming (DP) matching may be used for the comparison. In the DP matching, a difference between the typical time series of acceleration data and the recorded time series of acceleration data is calculated as a distance.

The action detecting unit 35 determines whether the distance is less than or equal to a threshold (S204). When the distance is less than or equal to the threshold (YES at S204), the action detecting unit 35 determines that the predefined action is detected (S205). On the other hand, when the distance is greater than the threshold (NO at S204), the action detecting unit 35 determines that the predefined action is not detected (S206).

Use of the DP matching is just an example, and any known pattern recognition technique may be used to detect the predefined action.

### <Process Performed by Server>

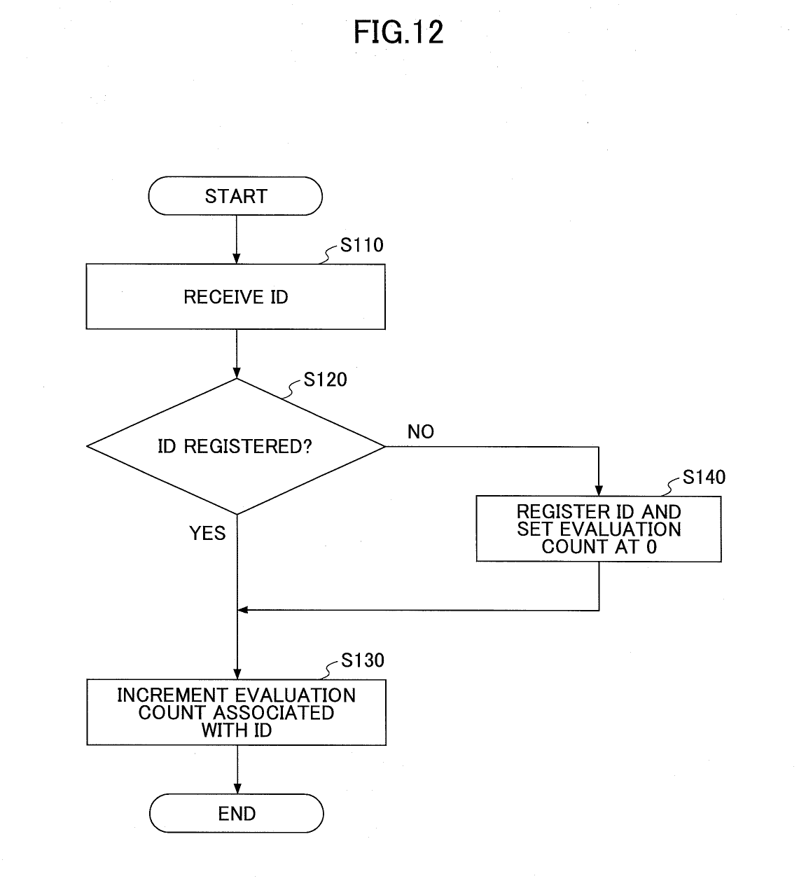

FIG. 12 is a flowchart illustrating an exemplary process performed by the server 13 to receive an ID.

In FIG. 12, the ID receiving unit 23 of the server 13 receives an ID (S110). Preferably, related information is also received at this step.

The ID determining unit 24 determines whether the received ID is registered in the evaluation information management DB 20 (S120). As described above, when IDs are assigned to the evaluation targets 11 without the involvement of the server 13, i.e., when duplicate IDs may exist, the ID determining unit 24 determines whether the received ID is registered based also on the related information.

When the ID is registered (YES at S120), the evaluation count incrementing unit 25 increments the evaluation count associated with the ID by 1 (S130). The evaluation count incrementing unit 25 may be configured to also update the evaluation count for each time range based on time information and update the evaluation count for each position (or area) based on positional information. This configuration makes it possible to determine a highly-evaluated evaluation target 11 for each time range and area.

Also, when the evaluation device 12 is configured to transmit the unique number to the server 13, the evaluation count incrementing unit 25 may count the number of transmitted IDs for each unique number. This makes it possible to determine an evaluator who is actively evaluating the evaluation targets 11 and give an incentive (e.g., a point) to the active evaluator.

When the ID is not registered (NO at S120), the ID determining unit 24 newly registers the ID in the evaluation result table and set the evaluation count of the ID at 0 (S140).

After step S140, the evaluation count incrementing unit 25 increments the evaluation count associated with the ID by 1 (S130).

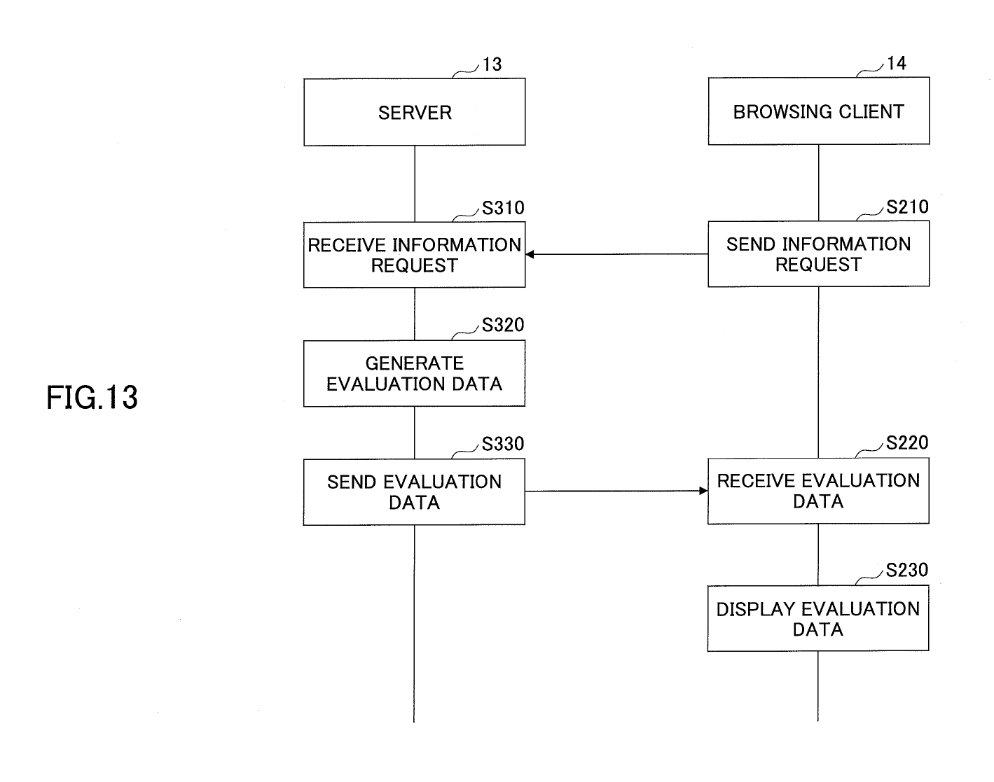

FIG. 13 is a flowchart illustrating an exemplary process where the browsing client 14 requests evaluation data from the server 13. Here, it is assumed that the top page has already been displayed by the browsing client 14.

In response to an operation performed by the evaluator, the browsing client 14 transmits an information request for an evaluation count with, for example, an ID specified as an argument (S210).

The information request receiving unit 27 of the server 13 receives the information request (S310).

The evaluation data generating unit 28 searches the evaluation information management DB 20 based on the ID to retrieve an evaluation count associated with the ID in the evaluation result table, and generates evaluation data including the ID and the evaluation count in, for example, an HTML format (S320). The evaluation data may also include the related information of the evaluation target 11 associated with the ID.

The evaluation data generating unit 28 may also be configured to calculate an evaluation count based on a totaling method (e.g., for each time range, region, or evaluator) attached to the information request and transmit the calculated evaluation count. For example, when the viewer and the evaluator are the same person (or the browsing client 14 and the evaluation device 12 are the same device), the browsing client 14 can transmit its unique number and the IDs of evaluation targets 11 stored when the viewer/evaluator evaluated the evaluation targets 11. This allows the viewer to view the evaluation counts of evaluation targets 11 that the viewer has evaluated.

The evaluation data transmission unit 29 transmits the generated evaluation data to the browsing client 14 (S330):

The browsing client 14 receives the evaluation data (S220), and parses and displays the evaluation data in the HTML format on a display (S230).

As described above, in the evaluation system 500 of the present embodiment, the evaluation device 12 obtains an ID from the evaluation target 11 (or the radio communication chip 15) and transmits the ID to the server in response to an operation by the evaluator. This configuration makes it possible to actively evaluate products and services in the real world through a simple operation. Also, the evaluation system 500 enables the viewer (or evaluator) to view evaluation counts of products and services.

### Second Embodiment

In a evaluation system according to a second embodiment, IDs are obtained in a manner different from that in the first embodiment.

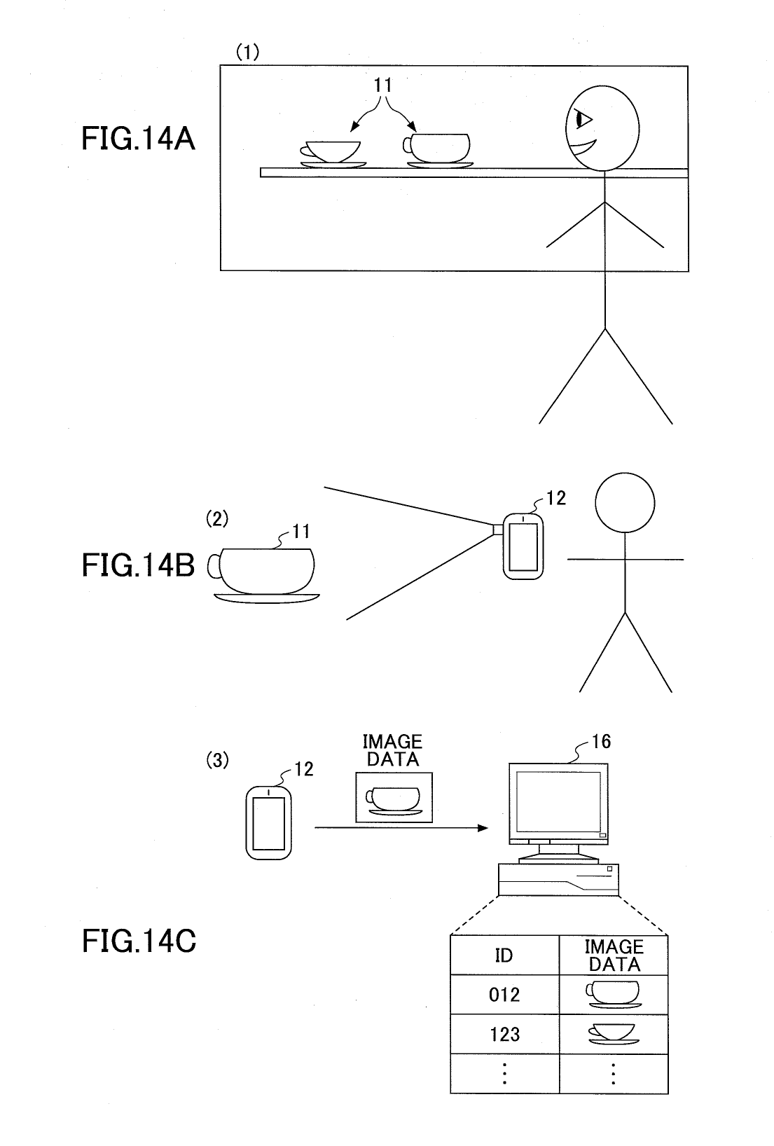

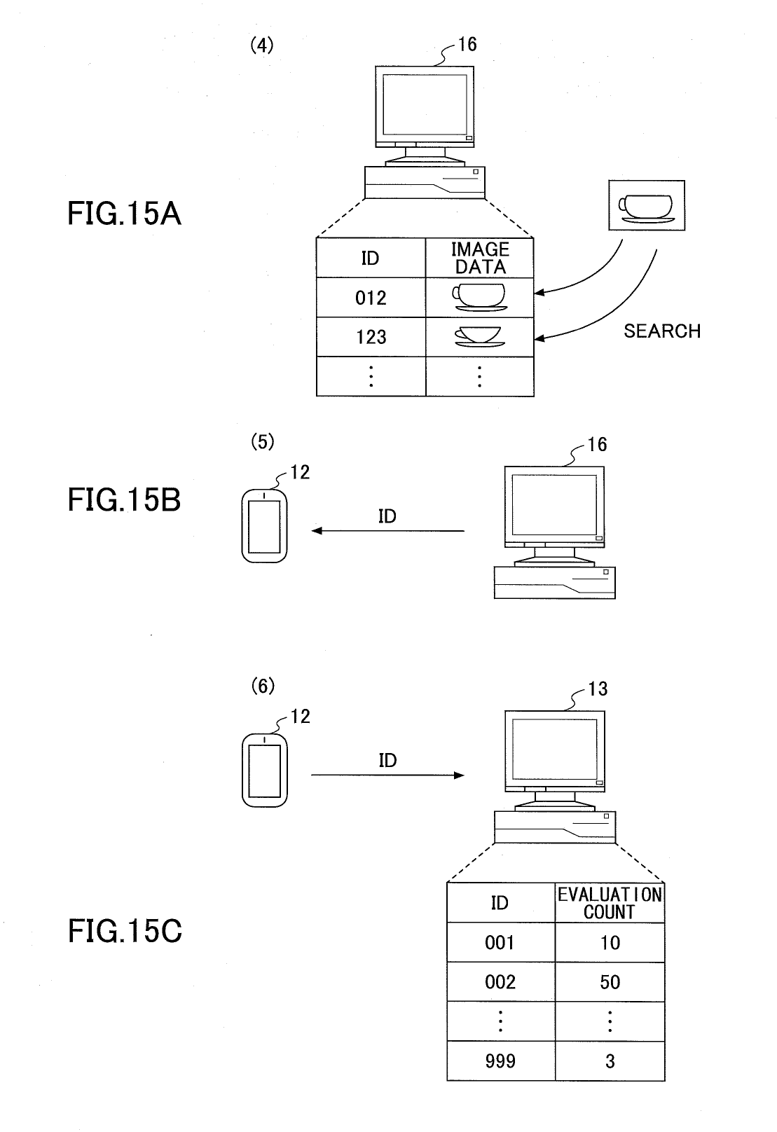

FIGS. 14A through 15C are drawings used to describe an exemplary schematic process performed in an evaluation system 500 according to the second embodiment. In the descriptions below, numbers in parentheses correspond to those in FIGS. 14A through 15C.

(1) An evaluator carries the evaluation device 12. The evaluation device 12 is, for example, a portable communication terminal. When the evaluator comes across an interesting evaluation target 11 while moving in the real world, the evaluator may generally reduce the walking speed or stop walking to look at the evaluation target 11.

(2) When the evaluator wants to evaluate the evaluation target 11, the evaluator captures image data (or take a picture) of the evaluation target 11 with the evaluation device 12 and performs a predefined action before or after capturing the image data. When the evaluation target 11 is a tangible object, image data of the evaluation target 11 itself is captured. On the other hand, when the evaluation target 11 is a service, image data of an object such as a signboard or a shop related to the service may be captured.

(3) The evaluation device 12 transmits the image data to a search server 16. The search server 16 includes an image database (DB) (or a feature database) where image data of evaluation targets 11 is stored in association with IDs.

(4) The search server 16 searches the image DB 42 based on the image data transmitted from the evaluation device 12 to identify an ID associated with the corresponding image data, i.e., the ID of the evaluation target 11.

(5) When an ID of the image data is identified, the search server 16 transmits the ID to the evaluation device 12.

(6) The evaluation device 12 transmits the ID to the server 13. The rest of the process is substantially the same as in the first embodiment, i.e., the server 13 increments the evaluation count associated with the ID in the evaluation result table.

Thus, according to the second embodiment, it is possible to obtain an ID by taking a picture of the evaluation target 11 without communicating with the radio communication chip 15 and to count the evaluation count as in the first embodiment.

### <Configuration>

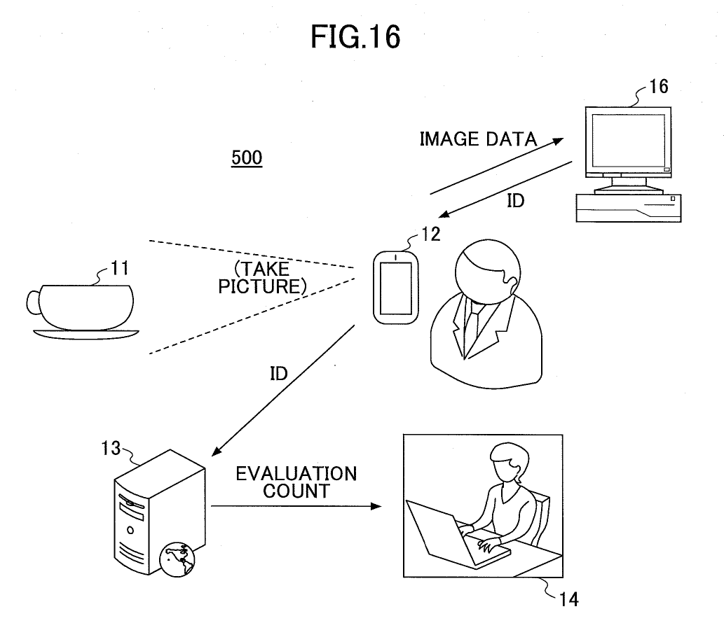

FIG. 16 is a schematic diagram illustrating an exemplary configuration of the evaluation system 500 of the second embodiment. Below, descriptions of components in FIG. 16 that correspond to components in FIG. 3 may be omitted. The evaluation system 500 of the second embodiment may include the evaluation target 11, the evaluation device 12, the server 13, and the search server 16.

In the second embodiment, the radio communication chip 15 is basically not provided for the evaluation target 11. Even when the radio communication chip 15 is provided for the evaluation target 11, the evaluation device 12 obtains the ID from the search server 16. The definition of the evaluation target 11 is the same as that in the first embodiment.

### <Evaluation Device>

The evaluation device 12 may be implemented by any device that includes the camera 110 is capable of communicating with the server 13 and the search server 16. For example, the evaluation device 12 may be implemented by a portable device such as a smartphone, a tablet, a straight PC, a cell phone, a personal digital assistant (PDA), or a notebook PC. Using such a portable device as the evaluation device 12 eliminates the need for an evaluator to carry an extra device dedicated to evaluating the evaluation targets 11.

The evaluator is supposed to capture image data of the evaluation target 11 such that the image data includes the entire view or a characteristic part of the evaluation target 11. For example, the evaluator captures image data of a product to include the entire view or a logo of the product. When the evaluation target 11 is a service, the evaluator may capture image data of, for example, an entire shop or a signboard of the shop. When the evaluation target 11 is a tourist spot, scenery, a place, or a space, the evaluator may capture image data of a nearby station, a nearby bus stop, a guideboard of a tourist spot, or the scenery itself. Image data of products and services as described above is registered in the search sever 16.

### <Search Server>

The search server 16 may be implemented by an information processing apparatus and have a hardware configuration similar to that of the server 13.

The search server 16 and the evaluation device 12 may communicate with each other via a network and a communication method that are similar to those used for communications between the server 13 and the evaluation device 12. Although the server 13 and the search server 16 are implemented as separate apparatuses in FIG. 16, the server 13 and the search server 16 may be implemented by one information processing apparatus. The search server 16 searches the image DB 42 for image data that matches image data captured by the evaluation device 12.

### <Functional Configuration>

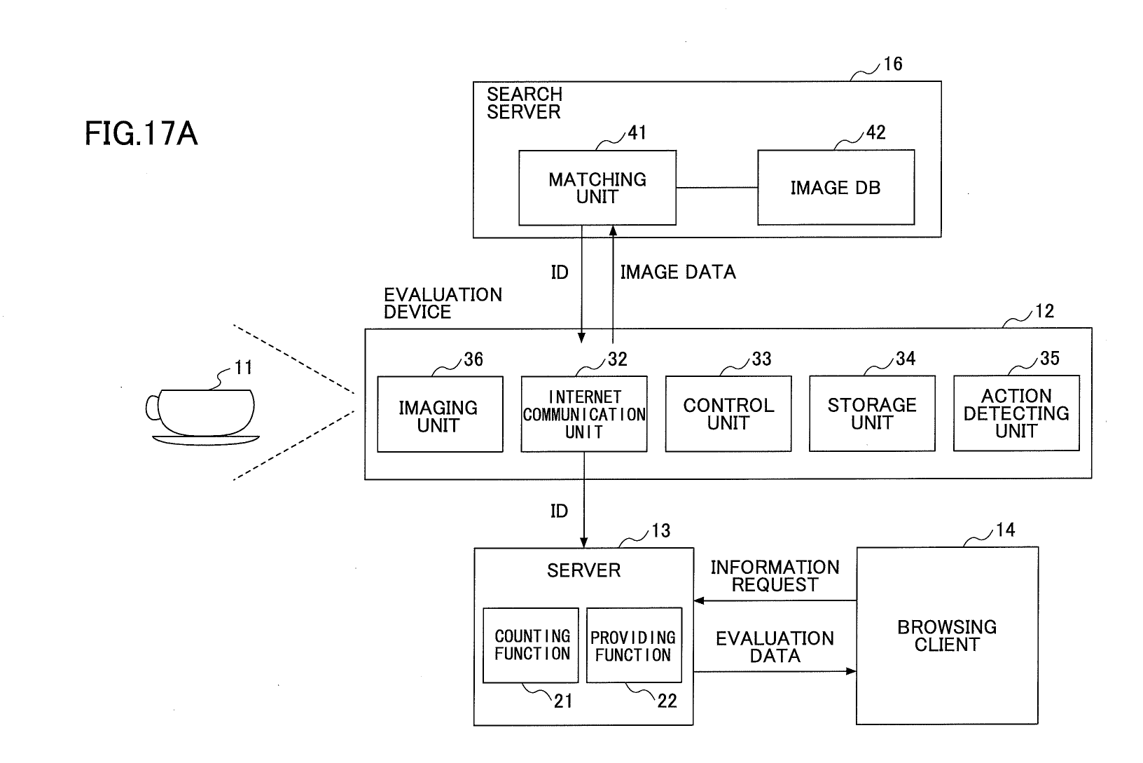

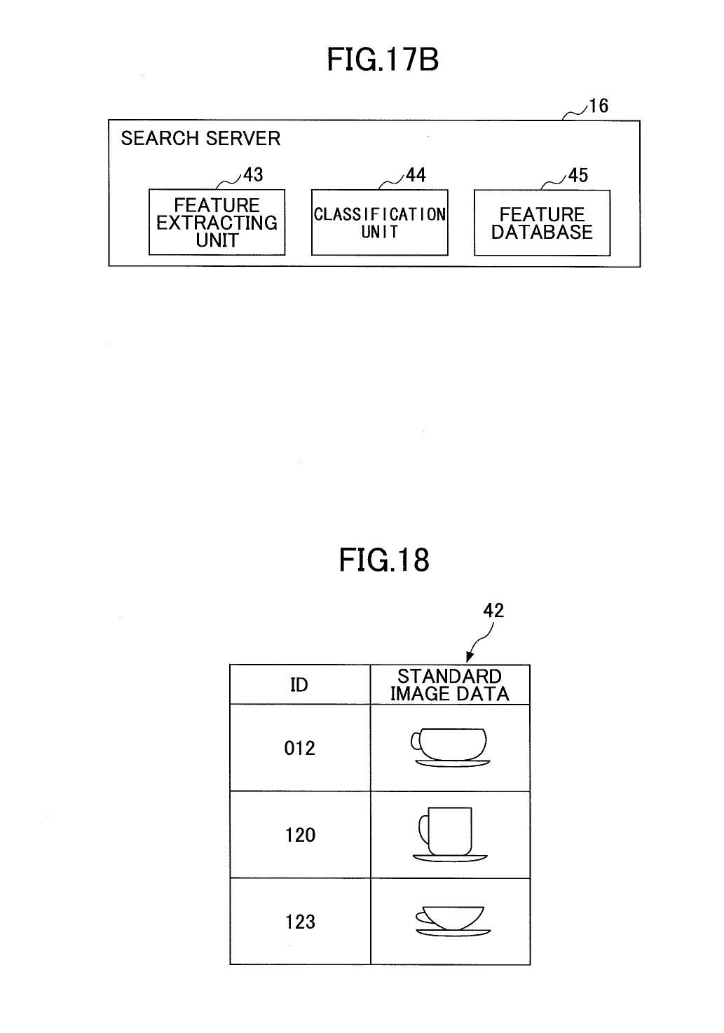

FIGS. 17A and 17B are block diagrams illustrating an exemplary functional configuration of the evaluation system 500 of the second embodiment. The functional configuration of the search server 16 in FIG. 17A is applied to a case where the search server 16 searches for image data by a pattern matching technique. The functional configuration of the search server 16 illustrated by FIG. 17B is applied to a case where the search server 16 searches for image data by a visual search technique.

Descriptions of components in FIGS. 17A and 17B corresponding to those in FIGS. 6A and 6B are omitted.

In the second embodiment, the evaluation device 12 is configured to communicate with the search server 16 as well as the server 13. Also in the second embodiment, the radio communication chip 15 is not necessary for the evaluation target 11 (but may still be provided for the evaluation target 11) and the communication unit 31 is not an essential component of the evaluation device 12. Meanwhile, the evaluation device 12 of the second embodiment includes an imaging unit 36 that captures image data of the evaluation target 11 with the camera 110.

The process from the capturing of image data to the reception of an ID may be performed in various manners. For example, this process may be initiated when a predefined action is detected by the action detecting unit 35. The imaging unit 36 captures image data of the evaluation target 11 using the camera 110. Similarly to the first embodiment, the evaluation device 12 is preferably configured to store time information and positional information indicating the time and position at which the image data is captured.

The Internet communication unit 32 controls the carrier communication unit 109 or the wireless LAN communication unit 108 to communicate with the search server 16 and transmit image data to the search server 16. The evaluator may capture image data of the same evaluation target 11 multiple times. Also, the imaging unit 36 may be configured to capture multiple sets of image data of the evaluation target 11 in response to one instruction from the evaluator to facilitate the search of the image DB 42. Thus, unlike the ID, multiple sets of image data of the same evaluation target 11 may be transmitted by the Internet communication unit 32 to the search sever 16.

In the second embodiment, capturing image data may be regarded as a predefined action. In this case, the evaluator can obtain an ID by just starting the program 114 and capturing image data of the evaluation target 11. Also, image data may be transmitted to the search server 16 when a predefined action is detected after the image data is captured. This enables the evaluator to review the image data.

The control unit 33 stores an ID received from the search server 16 in the storage unit 34. Then, the control unit 33 transmits the ID stored in the storage unit 34 to the server 13. The rest of the process is substantially the same as that in the first embodiment.

For example, the evaluation device 12 may perform one of the following processes:

1) Detect predefined action-->capture image data-->transmit image data to the search server 16-->receive ID-->transmit ID to the server 13

2) Capture image data (detected as predefined action)-->transmit image data to the search server 16-->receive ID-->transmit ID to the server 13

3) Capture image data-->detect predefined action-->transmit image data to the search server 16-->receive ID-->transmit ID to the server 13

The predefined action in process 1) is, for example, a gesture. For example, when the evaluator waves or swings the evaluation device 12 downward, the program 114 is started or the program 114, which has already been started, activates the imaging unit 36. When the evaluator captures image data of the evaluation target 11 with the camera 110, the imaging unit 36 stores the image data in the storage unit 34, and the control unit 33 transmits the image data to the search server 16.

In process 2), it is assumed that the program 114 and the imaging unit 36 have already been started. When the evaluator captures image data of the evaluation target 11 with the camera 110, the control unit 33 transmits the image data to the search server 16.

In process 3), the evaluator captures image data of the evaluation target 11 with the camera 110. When the evaluator views the image later and decides to evaluate the evaluation target 11, the evaluator starts the program 114 and transmits the image data to the search server 16 by performing a predefined action. The predefined action in process 3) is, for example, an operation on software keys generated by the program 114 or a touch panel. Alternatively, a gesture may be used to transmit the image data. For example, the evaluator can transmit one set of image data by swinging the evaluation device 12 downward once and can transmit multiple sets of image data by swinging the evaluation device 12 downward for the corresponding number of times.

### <Search Process Performed by Search Server>

Search methods employed by the search server 16 are described below. The search server 16 may use the following search methods to search for image data:

A. Pattern Matching

B. Visual Search (used to search for text image data)

### [A. Pattern Matching]

As illustrated in FIG. 17A, the search server 16 may include a matching unit 41 and the image DB 42. The image DB 42 stores standard image data in association with IDs. The standard image data is obtained by capturing image data of evaluation targets 11 or by converting the image data into feature data. One or more sets of standard image data may be associated with one evaluation target 11. For example, when the evaluation target 11 is a coffee cup, multiple sets of image data obtained by shooting the coffee cup from different angles may be used as the standard image data. The standard image data may be either in color or grayscale.

FIG. 18 is a drawing illustrating an example of the image DB 42. The image DB 42 stores one or more sets of standard image data for each ID. The ID is identification information for identifying the evaluation target 11 as in the first embodiment, but is not necessarily stored in the radio communication chip 15. The ID is assigned by the search server 16 and is unique within a range or area (e.g., the entire world, a country, or a region) where the evaluation system 500 is intended to be used. All IDs registered in the image DB of the search server 16 are also registered in the evaluation information management DB 20 of the server 13.

The matching unit 41 identifies standard image data that is highly correlated with image data received from the evaluation device 12, and transmits the ID of the identified standard image data to the evaluation device 12.

The matching unit 41 may be configured to perform preprocessing on the received image data before comparing it with standard image data. Examples of the preprocessing may include a process of increasing or reducing the size of the image data to match the size of the standard image data, a process of changing the color space of the image data to match the color space of the standard image data, a process of changing the brightness level of the image data to match the brightness level of the standard image data, and edge processing. The matching unit 41 uses a known pattern matching technique such as Sum of Absolute Difference (SAD), Sum of Squared Difference (SSD), or Normalized Cross Correlation (NCC) for each pixel or pixel block. In SAD and SSD, a smaller value indicates a higher correlation. In NCC, a value closer to 1 indicates a higher correlation.

The matching unit 41 identifies standard image data with the highest correlation value and retrieves the ID associated with the standard image data when the correlation value of the standard image data is greater than or equal to a threshold. When the correlation values of multiple sets of standard image data are greater than or equal to the threshold, the matching unit 41 may retrieve all of the IDs of the multiple sets of standard image data.

When no standard image data whose correlation value is greater than or equal to the threshold is found, the matching unit 41 newly assigns an ID to the image data received from the evaluation device 12 and registers the image data as standard image data in the image DB 42. This configuration makes it possible to automatically register standard image data.

Also, the matching unit 41 may be configured to search the Internet for image data when no standard image data whose correlation value is greater than or equal to the threshold is found. In this case, the matching unit 41 identifies one or more sets of highly-correlated image data on the Internet and collects target information of the identified image data. Because image data on the Internet is generally accompanied by text describing, for example, its name, provider, and price, it is possible to collect target information of the image data. This process may instead be performed by the server 13.

When standard image data is identified, the search server 16 transmits the corresponding ID to the evaluation device 12. The evaluation device 12 transmits the ID to the server 13 preferably together with related information. Then, similarly to the first embodiment, the server 13 increments the evaluation count and registers the related information.

In the above described process, the evaluation device 12 transmits image data to the search server 16, the search server 16 transmits an ID to the evaluation device 12, and the evaluation device 12 transfers the ID to the server 13. Alternatively, the search server 16 may be configured to transmit the ID directly to the server 13. In this case, the evaluation device 12 can complete an evaluation process by just transmitting image data to the search server 16. This also applies to a case where the server 13 and the search server 16 are implemented by the same information processing apparatus.

### [B. Visual Search]

As illustrated by FIG. 17B, the search server may include a feature extracting unit 43, a classification unit 44, and a feature database 45.

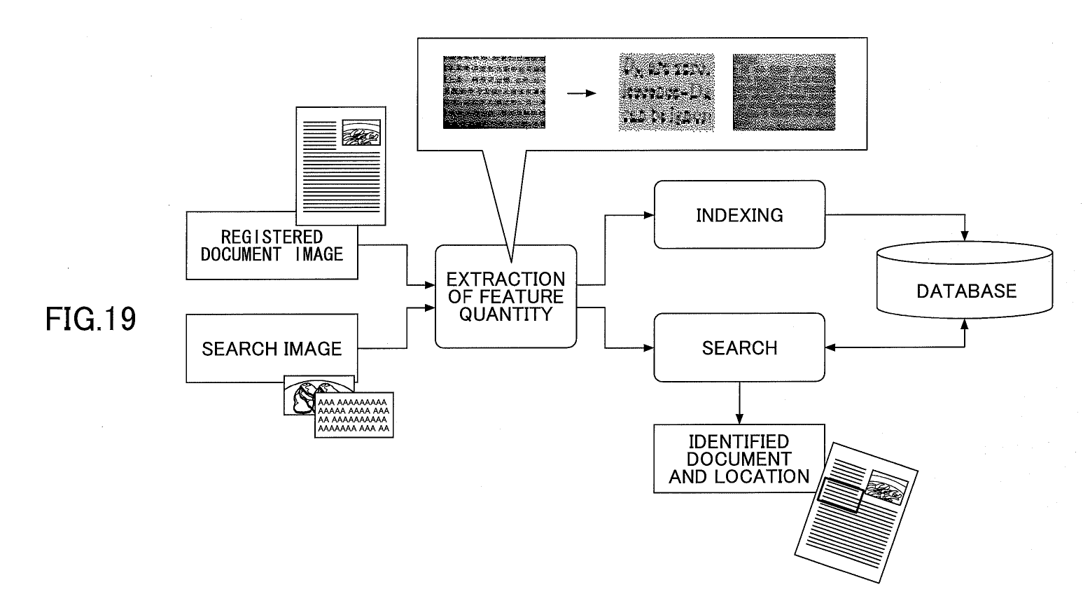

FIG. 19 is a drawing used to describe an exemplary visual search process. “Visual search” is a technique where feature quantities of document images are extracted and compared with each other. In FIG. 19, a registered document image indicates a document image whose feature quantity is registered beforehand, and a search image indicates an image captured by the evaluation device 12. Here, “feature quantity” indicates values representing characteristic arrangement of text. An index number is assigned to the registered document image and the index number corresponds to an ID in the present embodiment.

For example, when the evaluator captures a document image of a part of a newspaper or a magazine article with the camera 110 of the evaluation device 12 and transmits the captured document image to the search server 16, the search server 16 extracts a feature quantity from the captured document image and compares the extracted feature quantity with feature quantities of registered document images in the feature database 45. The search server 16 can identify a registered document image and also a position on a page of the registered document image by the comparison.

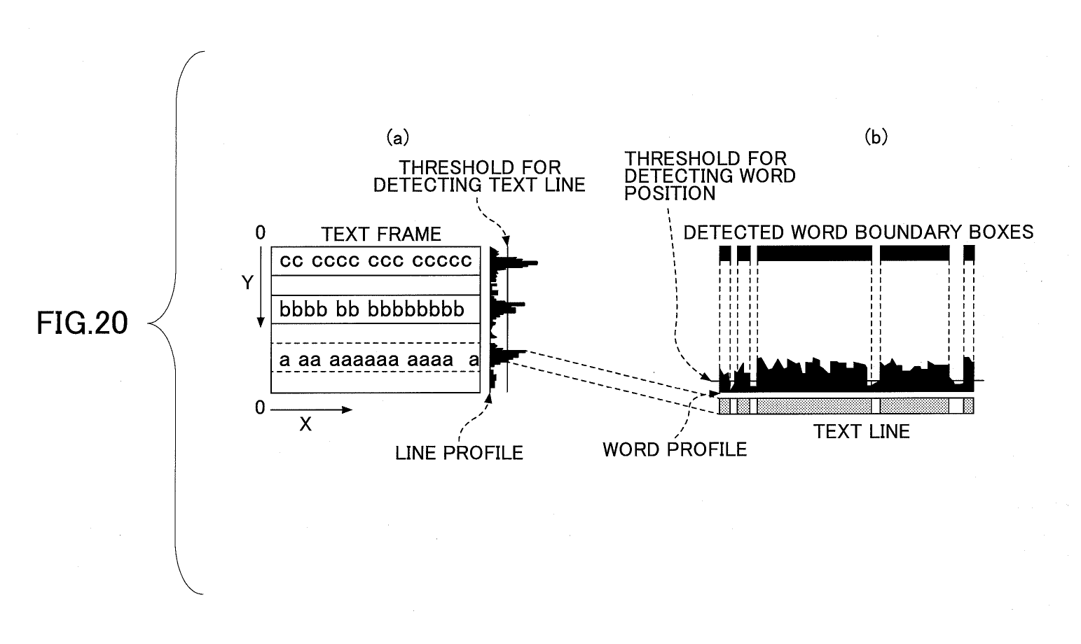

The feature quantity is described below. FIG. 20 is a drawing used to describe an exemplary word boundary box determination algorithm. “Word boundary box determination” is a process of determining boundaries of English words. When text is written in a language such as Japanese where words are not explicitly separated by spaces, spaces (or blanks) generated by punctuation marks such as “,” and “.” may be determined.

In the word boundary box determination process, skew correction is performed on a document image to align text lines horizontally. As illustrated in FIG. 20 (a), the feature extracting unit 43 calculates a horizontal projection profile (plan view characteristics) of the document image. That is, the feature extracting unit 43 calculates a histogram of pixels in the horizontal direction, and determines a vertical range where the value exceeds a threshold as a line (text line).

After determining lines, the feature extracting unit 43 identifies word regions in each of the lines. More specifically, as illustrated by FIG. 20 (b), the feature extracting unit 43 calculates a vertical projection profile (plan view characteristics) of the document image. That is, the feature extracting unit 43 calculates a histogram of pixels in the vertical direction, and determines a horizontal range where the value exceeds a threshold as a word.

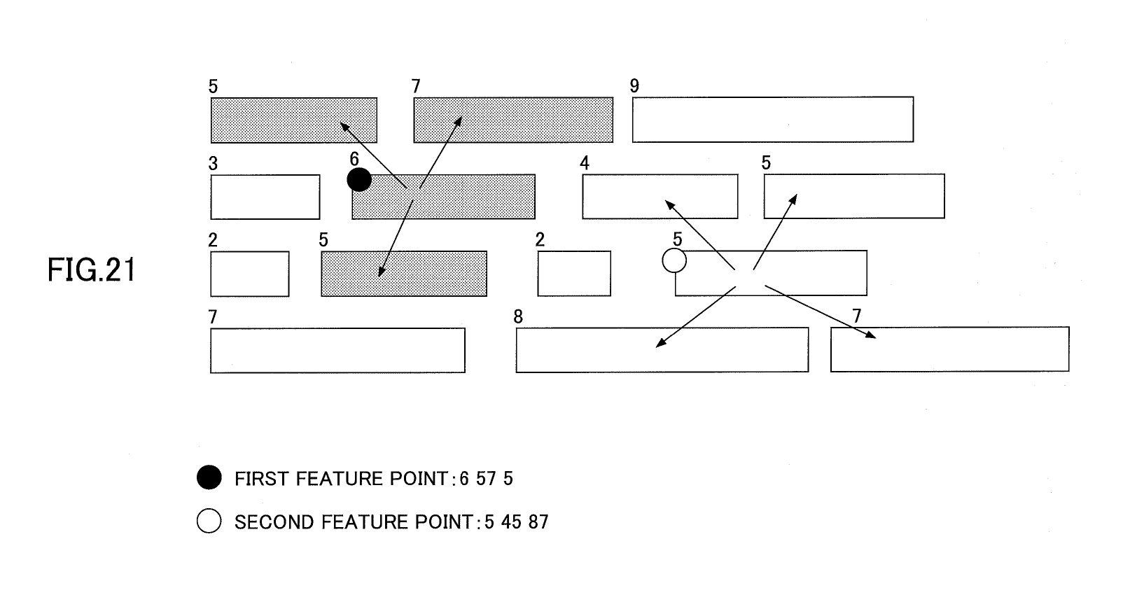

FIG. 21 is a drawing illustrating grouping of words based on word boundaries. The circumscribing rectangle of each word detected in the process of FIG. 20 is referred to as a “word boundary”. Extracted word boundaries are formed into groups. A group is formed, for example, by at least three words whose word boundaries overlap each other vertically. For example, in FIG. 21, a front (left) part of the word boundary of a first feature point (the second word box in the second line that has a length of 6 and is indicated by a black circle) overlaps the first word box (with a length of 5) in the first line, and a rear (right) part of the word boundary of the first feature point overlaps the second word box (with a length of 7) in the first line. Also, the front part of the word boundary of the first feature point overlaps the second word box (with a length of 5) in the third line.

A front part of the word boundary of a second feature point (the fourth word box in the third line that has a length of 5 and is indicated by a white circle) overlaps the third word box (with a length of 4) in the second line, and a rear part of the word boundary of the second feature point overlaps the fourth word box (with a length of 5) in the second line. Also, the front part of the word boundary of the second feature point overlaps the second word box (with a length of 8) in the fourth line, and the rear part of the word boundary of the second feature point overlaps the third word box (with a length of 7) in the fourth line.

As illustrated in FIG. 21, each feature point is represented by numerals indicating the length of its word box, the length(s) of an upper (overlapping) word box(es), and the length(s) of lower (overlapping) word box(es). In the example of FIG. 21, the feature point is set at the upper-left corner of the word boundary. However, the feature point may be set at any other corner of the word boundary.

First feature point: 6 57 5

Second feature point: 5 45 87

The length of the word box may be based on any metric (or unit).

Next, a method of extracting a feature quantity where spaces are represented by 0s and word regions are represented by 1s is described.

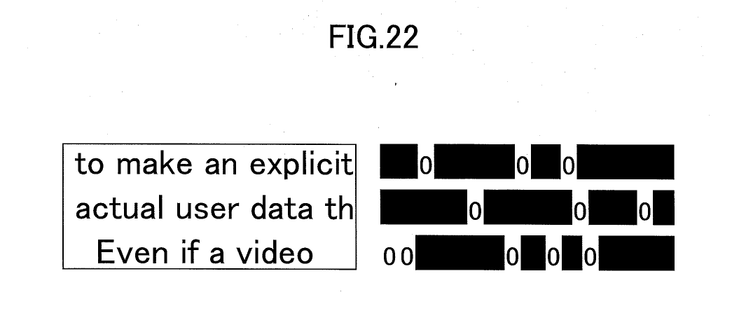

FIG. 22 is a drawing used to describe a feature quantity represented by 0s and 1s. In FIG. 22, a block representation on the right side corresponds to word and space regions in a document image (patch) on the left side. In the block representation, word regions are represented by black pixels and spaces are represented by 0s.

In this case, distances between 0s may be used as a feature quantity. The extracted feature quantity may be compared with various distance indices such as the norm and the Hamming distance. Also, a hash table may be used to identify a document patch having the same feature quantity as that of a query image.

Next, calculation of angles formed by feature points is described.

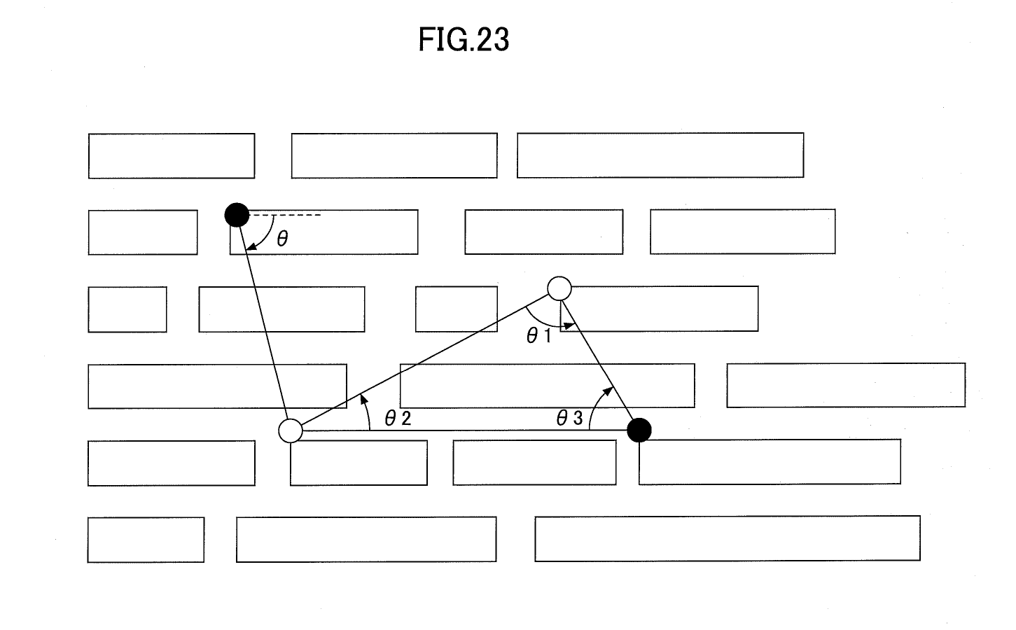

FIG. 23 is a drawing used to describe an exemplary method of calculating angles formed by word boundaries. In FIG. 23, interior angles θ1-θ3 of a triangle connecting three word boundaries are calculated. In the calculation of angles, any combination of three or more word boxes may be selected or word boundaries forming a group as illustrated in FIG. 21 may be selected. Any method may be used to select words (word boxes or word boundaries) for this purpose.

The calculated angles are compared with angles formed by feature points in a query image. For example, a similarity score may be increased when one or more angles formed by feature points in a query image are similar to those registered in the feature database 45. Also, the similarity score may be increased when a group of angles in a query image are similar to or the same as a registered group of angles in an image. After similarity scores between a query image and extracted document patches are calculated, one of the extracted document patches with the highest similarity score may be selected, and the highest similarity score may be compared with an adaptive threshold to determine whether the similarity satisfies a given criterion. When the similarity satisfies the criterion, it is determined that a matching document patch is found.

Also, a word length may be used as a feature quantity.

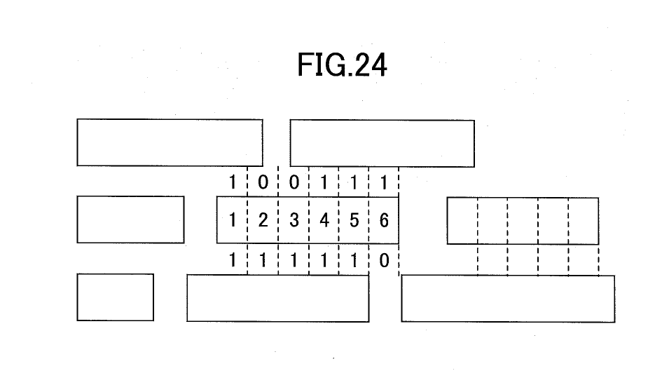

FIG. 24 is a drawing used to describe a feature quantity based on a word length. As illustrated by FIG. 24, the feature extracting unit 43 divides each word into presumed characters based on the height and width of the word. The feature quantity is represented by (i) the length of a target (or current) word, (ii) a text arrangement of a line above the target word, and (iii) a text arrangement of a line below the target word. The text arrangement is represented by 1s is and 0s indicating characters and spaces in the line above or below the target word.

When the number of characters of the target word is 6, each of the text arrangement (ii) and the text arrangement (iii) is represented by a binary number of 6 bits. In the example of FIG. 24, a word exists above the first presumed character of the target word, a space exists above the second and third presumed characters, and a word exists above the fourth through sixth presumed characters. Also, a word exists below the first through fifth presumed characters of the target word and a space exists below the sixth presumed character. Accordingly, the feature quantity of the target word is represented by “6, 100111, 111110”. When the binary numbers are converted into integers, the feature quantity of the target word is represented by “6, 39, 62”.

An exemplary method performed by the classification unit 44 to compare a document image with each registered document image is described below. The classification unit 44 extracts the lengths of adjacent words that are adjacent in the horizontal and vertical directions, and calculates the ranking of each patch in the feature database 45. This is based on a fact that a text image includes two independent sources for its identity and a document can be identified based on word layouts in the horizontal and vertical directions. In the descriptions below, document images are compared using the lengths of adjacent words as feature quantities. However, the comparison can be performed based on any one of the feature quantities described with reference to FIGS. 21 through 24 or a combination of one or more of the feature quantities.

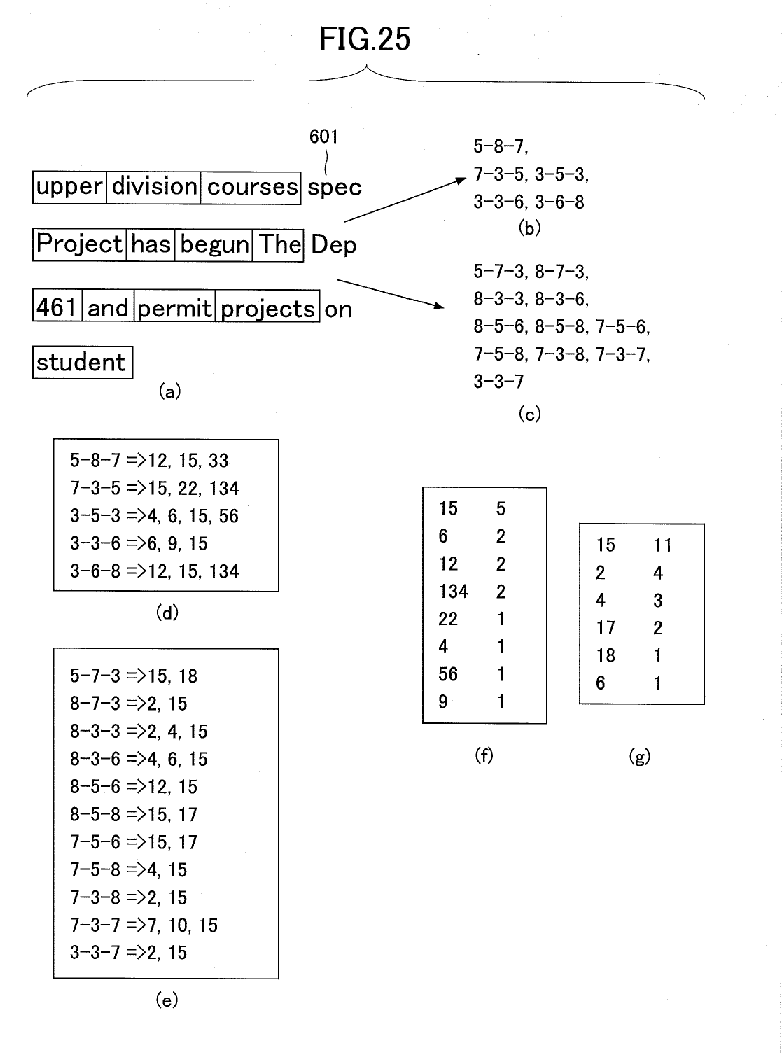

FIG. 25 is a drawing illustrating an exemplary method of combining a vertical layout and a horizontal layout. FIG. 25 (a) illustrates a document image (patch) 601 divided into words. Based on the document image 601, horizontal and vertical “n-grams” are determined. The “n-gram” is a notation for describing a feature quantity using sequences of “n” numerals. For example, a horizontal trigram indicates the number of characters in each of three words (horizontal sequence) that are adjacent to each other in the horizontal direction. Horizontal and vertical trigrams of the document image of FIG. 25 (a) are shown below.

### (Horizontal Trigrams)

5-8-7 (“upper”, “division”, and “courses”)

7-3-5 (“Project”, “has”, and “begun”)

3-5-3 (“has”, “begun”, and “The”)

3-3-6 (“461”, “and”, and “permit”)

3-6-8 (“and”, “permit”, and “projects”)

### (Vertical Trigrams)

5-7-3 (“upper”, “Project”, and “461”)

8-7-3 (“division”, “Project”, and “461”)

8-3-3 (“division”, “has”, and “and”)

8-3-6 (“division”, “has”, and “permit”)

8-5-6 (“division”, “begun”, and “permit”)

8-5-8 (“division”, “begun”, and “projects”)

7-5-6 (“courses”, “begun”, and “permit”)

7-5-8 (“courses”, “begun”, and “projects”)

7-3-8 (“courses”, “The”, and “projects”)

7-3-7 (“Project”, “461”, and “student”)

3-3-7 (“has”, “and”, and “student”)

The classification unit 44 searches the feature database 45 for a document that includes the horizontal and vertical trigrams determined as described above. FIG. 25 (d) illustrates exemplary search results of the horizontal trigrams, and FIG. 25 (e) illustrates exemplary search results of the vertical trigrams. In the search results, for example, the horizontal trigram 1-3-5 is found in registered document images with index numbers 15, 22, and 134; and the vertical trigram 7-5-6 is found in registered document images with index numbers 15 and 17.

FIG. 25 (f) is an exemplary horizontal-trigram ranking list listing registered document images that are ranked in descending order of the number of horizontal trigrams found therein. In the example of FIG. 25 (f), five horizontal trigrams are found in a registered document image with index number 5, but only one horizontal trigram is found in a registered document image with index number 9. FIG. 25 (g) is an exemplary vertical-trigram ranking list listing registered document images that are ranked in descending order of the number of vertical trigrams found therein. In the example of FIG. 25 (g), eleven vertical trigrams are found in a registered document image with index number 15, but only one vertical trigram is found in a registered document image with index number 18.

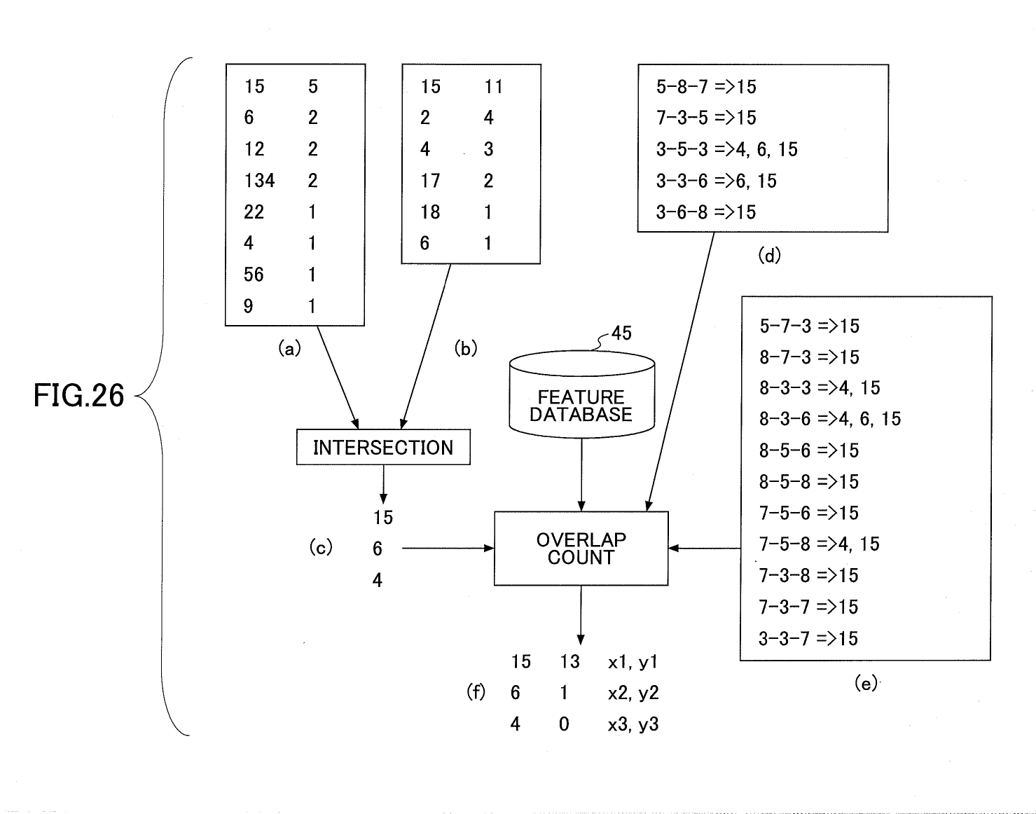

FIG. 26 is a drawing used to describe an exemplary method of combining horizontal trigram information and vertical trigram information obtained in FIG. 25. The classification unit 44 combines vote lists obtained from extracted horizontal and vertical features using information on known physical locations of trigrams in registered document images. First, registered document images, which are present both in a horizontal-trigram ranking list listing top M registered document images including the corresponding horizontal trigrams and a vertical-trigram ranking list listing top M registered document images including the corresponding vertical trigrams, are identified. Then, the locations of all the horizontal trigrams in each identified registered document image are compared with the locations of all the vertical trigrams in the identified registered document image. When all of the horizontal trigrams overlap the vertical trigrams, the identified registered document image receives votes corresponding to the number of the horizontal trigrams. Here, a horizontal trigram and a vertical trigram “overlap” each other when their boundary boxes overlap each other. That is, “overlapping” here indicates a case where one or more words of a horizontal trigram overlap those of a vertical trigram.

For example, based on the lists of FIGS. 26 (a) and (b) (that are the same as the lists of FIGS. 25 (f) and (g)), the classification unit 44 generates a list (FIG. 26 (c)) of registered document images each of which includes both horizontal and vertical trigrams (i.e., registered document images listed in both of the lists of FIGS. 26 (a) and (b)).

FIG. 26 (d) is a list of horizontal trigrams that are in the list of FIG. 25 (d) and corresponding to the registered document images in the list of FIG. 26 (c). FIG. 26 (e) is a list of vertical trigrams that are in the list of FIG. 25 (e) and corresponding to the registered document images in the list of FIG. 26 (c).

Based on the lists of FIGS. 26 (c), (d), and (e) and the feature database 45, the classification unit 44 identifies overlapping of trigrams in each registered document image. For example, the registered document image with index number 6 includes the horizontal trigram 3-5-3 and the vertical trigram 8-3-6, and these trigrams overlap each other by a word “has” in the document image 601. In this case, the registered document image with index number 6 receives one vote for the overlap (one vote for each overlap).

FIG. 26 (f) exemplifies the number of votes that each of the registered document images with index numbers 15, 6, and 4 has received. In the case of the document image 601, the registered document image with index number 15 has received the largest number of votes and is therefore identified as a document including the document image 601. In FIG. 26 (f), “x1,y1” indicates the location of an input image (i.e., the document image 601) in the registered document image with index number 15.

Although trigrams are used in the descriptions above, any “n-grams” may be used for extracting and classifying horizontal and/or vertical features. For example, n-grams where “n” represents 4 and 5 may be used for extracting vertical and horizontal features.

Also, classification may be performed based on adjacency that is not precisely vertical or horizontal. For example, the adjacency in northwest (NW), southwest (SW), northeast (NE), and southeast (SE) directions may be used for feature extraction and classification.

As described above, when text is evaluated by the evaluator, using a visual search technique makes it possible to accurately identify the text based on image data of the text. For example, when an ID is assigned to each magazine article or to each magazine, the above described technology enables the evaluator to evaluate an article while reading the article. This in turn makes it possible to count the evaluation counts of magazine articles and magazines and create a ranking of highly-evaluated articles and magazines.

### <Evaluation Process>

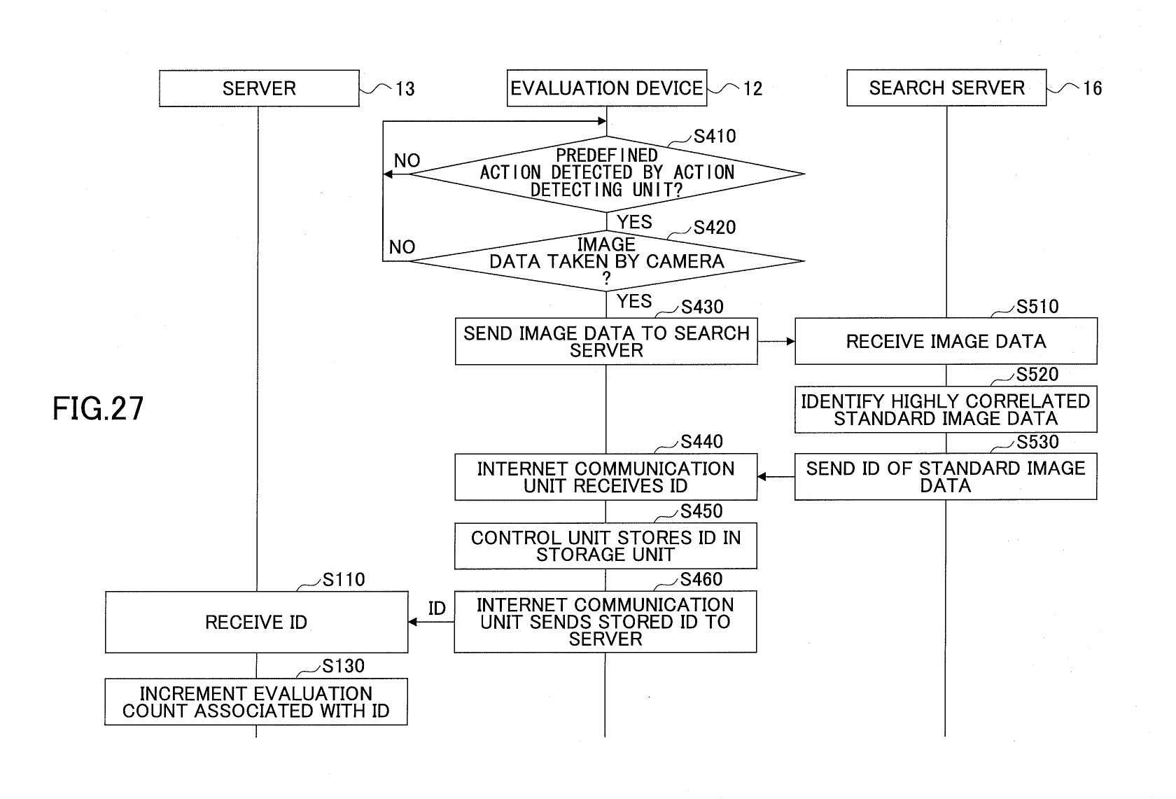

FIG. 27 is a flowchart illustrating an exemplary process where the evaluation device 12 transmits image data to the search server 16. In FIG. 27, it is assumed that the program 114 is running on the evaluation device 12. The process of FIG. 27 roughly corresponds to process 1) described above.

The action detecting unit 35 detects a predefined action (S410). The program 114 may instead be started when the predefined action is detected.

When the evaluator captures image data of the evaluation target 11 with the camera 110 (YES at S420), the internet communication unit 32 transmits the image data to the search server 16 (S430).

The search server 16 receives the image data (S510). The matching unit 41 of the search server 16 identifies standard image data that is highly-correlated with the received image data (S520). The search server 16 transmits the ID of the identified standard image data to the evaluation device 12 (S530).

When the internet communication unit 32 of the evaluation device 12 receives the ID (S440), the control unit 33 stores the ID in the storage unit 34 (S450).

The internet communication unit 32 transmits the ID stored in the storage unit 34 to the server 13 (S460).

The ID receiving unit 23 of the server 13 receives the ID (S110).

In the present embodiment, it is assumed that the ID is registered in the evaluation result table. Therefore, the evaluation count incrementing unit 25 increments the evaluation count associated with the ID by 1 (S130).

When process 2) described above is employed, steps S410 and S420 are combined into one step. When process 3) described above is employed, the order of steps S410 and S420 is reversed.

As described above, the evaluation system 500 of the second embodiment makes it possible to evaluate even an evaluation target without an ID by taking a picture of the evaluation target. Also, the second embodiment makes it possible to accurately identify text and its location in magazines and books and thereby makes it possible to evaluate magazines and books. The first embodiment and the second embodiment may be combined.

An aspect of this disclosure provides a non-transitory computer-readable storage medium storing a program for causing a computer to function as an action detecting unit that detects a predefined action, an identification information obtaining unit that obtains identification information of an evaluation target when the predefined action is detected by the action detecting unit, an identification information storing unit that stores the obtained identification information in a storage, and a transmitting unit that transmits the identification information stored in the storage to an external apparatus that calculates evaluation information of the evaluation target and thereby causes the external apparatus to update the evaluation information of the evaluation target that is stored in the external apparatus in association with the identification information.

An aspect of this disclosure provides an evaluation system, an evaluation method, and a storage medium that enables an evaluator to actively evaluate products and services in the real world.

An evaluation system, an evaluation method, and a storage medium are described above as preferred embodiments. However, the present invention is not limited to the specifically disclosed embodiments, and variations and modifications may be made without departing from the scope of the present invention.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An evaluation system, comprising:
a device including a processor and a memory storing a program; and
a first external apparatus,
wherein the program is configured to cause the processor to function as
an action detecting unit that detects a predefined action,
an identification information obtaining unit that obtains identification information of an evaluation target when the predefined action is detected by the action detecting unit,
an identification information storing unit that stores the obtained identification information in a storage, and
a transmitting unit that transmits the identification information stored in the storage to the first external apparatus; and
wherein the first external apparatus includes an evaluation information calculating unit that calculates and updates evaluation information of the evaluation target associated with the identification information received from the device.

2. The evaluation system as claimed in claim 1, wherein
the device includes a radio communication unit; and
the identification information obtaining unit controls the radio communication unit to wirelessly communicate with the evaluation target to receive the identification information from the evaluation target.

3. The evaluation system as claimed in claim 1, further comprising:
a second external apparatus that stores at least one of image data of the evaluation target and a feature quantity of the image data in association with the identification information of the evaluation target,
wherein the device includes an imaging unit;
wherein the identification information obtaining unit controls the imaging unit to capture image data of the evaluation target and controls the transmitting unit to transmit the captured image data to the second external apparatus; and
wherein the second external apparatus identifies the identification information of the evaluation target based on the captured image data received from the device and transmits the identified identification information to the device.

4. The evaluation system as claimed in claim 1, wherein when communications with the first external apparatus is not possible, the transmitting unit waits until the communications with the first external apparatus become possible and then transmits the identification information stored in the storage to the first external apparatus.

5. The evaluation system as claimed in claim 2, wherein when the radio communication unit receives multiple sets of the identification information from a plurality of the evaluation targets within a predetermined period of time, the transmitting unit transmits one of the sets of the identification information that is received with a highest signal intensity to the first external apparatus.

6. The evaluation system as claimed in claim 1, wherein
the program is configured to cause the processor to also function as
a receiving unit that receives the evaluation information from the first external apparatus, and
a displaying unit that displays the evaluation information on a display.

7. The evaluation system as claimed in claim 6,
wherein the first external apparatus stores a table where the identification information is associated with the evaluation information, a name of the evaluation target corresponding to the identification information, and target identification information assigned to the evaluation target by a provider thereof;
wherein when the identification information is received from the device, the first external apparatus transmits at least one of the name and the target identification information associated with the identification information to the device;
wherein when the name is received from the device, the first external apparatus transmits at least one of the identification information and the target identification information associated with the name to the device; and
wherein when the target identification information is received from the device, the first external apparatus transmits at least one of the name and the identification information associated with the target identification information to the device.

8. The evaluation system as claimed in claim 2,
wherein the transmitting unit transmits time information indicating a time when the radio communication unit receives the identification information from the evaluation target to the first external apparatus together with the identification information; and
wherein the first external apparatus calculates the evaluation information for each time range based on the time information.

9. The evaluation system as claimed in claim 1, wherein
the device includes an acceleration detection unit; and
the action detecting unit controls the acceleration detection unit to record a series of acceleration data of the device and determines that the predefined action is detected when the recorded series of acceleration data matches a predefined series of acceleration data.

10. A non-transitory computer-readable storage medium storing a program for causing a computer to function as
an action detecting unit that detects a predefined action,
an identification information obtaining unit that obtains identification information of an evaluation target when the predefined action is detected by the action detecting unit,
an identification information storing unit that stores the obtained identification information in a storage, and
a transmitting unit that transmits the identification information stored in the storage to an external apparatus that calculates evaluation information of the evaluation target.

11. A method performed by a device and an external apparatus of an evaluation system, the method comprising:
detecting a predefined action by the device;
obtaining identification information of an evaluation target by the device when the predefined action is detected;
storing the obtained identification information in a storage by the device;
transmitting, by the device, the identification information stored in the storage to the external apparatus; and
calculating and updating, by the external apparatus, evaluation information of the evaluation target associated with the identification information received from the device.
